(19) United States
(12) Patent Application Publication
(10) Pub. No.: US 2026/0194015 A1
(43) Pub. Date: Jul. 9, 2026

(54) GAS TURBINE ENGINE HAVING COMPOSITE FAN BLADES

(71) Applicant: General Electric Company, Evendale, OH (US)

(72) Inventors: Arthur William Sibbach, Boxford, MA (US); Gary Willard Bryant, JR., Loveland, OH (US)

(21) Appl. No.: 19/558,747

(22) Filed: Mar. 6, 2026

Related U.S. Application Data
(63) Continuation-in-part of application No. 19/362,542, filed on Oct. 20, 2025.
Application No. 19/362,542 is a continuation of application No. 18/909,259, filed on Oct. 8, 2024, now Pat. No. 12,473,863.
Application No. 18/909,259 is a continuation-in-part of application No. 18/603,773, filed on Mar. 13, 2024, now Pat. No. 12,473,832.

(51) Int. Cl. F02C 7/36

(52) U.S. Cl. CPC F02C 7/36; F05D 2220/36; F05D 2260/4031

(57) ABSTRACT

A gas turbine engine includes a drive turbine, a fan, and a gearbox. The fan has a fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}. The gearbox mechanically couples the drive turbine to the fan. The gas turbine engine defines a Fan Leading Edge to Trailing Edge Compression Factor (FLTCF) greater than or equal to 1.05 and less than or equal to 1.8. The drive turbine includes an area ratio equal to the annular exit area of an aft-most rotating stage divided by the annular exit area of a forward-most rotating stage. In some instances, the area ratio is within a range of 2.0-6.5. Additionally (or alternatively), the low-pressure turbine includes an area-EGT ratio within a range of 1.05-1.6.

### CROSS-REFERENCE TO RELATED APPLICATIONS

This application is a continuation-in-part of U.S. application Ser. No. 19/362,542, filed Oct. 20, 2025, which is a continuation of U.S. application Ser. No. 18/909,259, filed Oct. 8, 2024, now U.S. Pat. No. 12,473,863, which is a continuation-in-part of U.S. application Ser. No. 18/603,773, filed Mar. 13, 2024, now U.S. Pat. No. 12,473,832. Each related application is incorporated by reference herein in its entirety.

### FIELD

The present disclosure relates to a gas turbine engine having composite fan blades.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extract energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up view of a blade of the gas turbine engine of FIG. 1 in accordance with an exemplary aspect of the present disclosure.

FIG. 3 is a table of example engines of the present disclosure.

FIG. 4 is a cross-sectional view of a gas turbine engine in accordance with another exemplary aspect of the present disclosure

FIG. 5A is a cross-sectional schematic illustration of an example of a low-pressure turbine comprising three rotating blade stages, according to the present disclosure.

FIG. 5B is a cross-sectional schematic illustration depicting an exit area of a first rotating blade stage of the low-pressure turbine of FIG. 5A, according to the present disclosure.

FIG. 6 is a cross-sectional schematic illustration of another example of a low-pressure turbine comprising three rotating blade stages, according to the present disclosure.

FIG. 7 is a cross-sectional schematic illustration of another example of a low-pressure turbine comprising three rotating blade stages, according to the present disclosure.

FIG. 8 is a cross-sectional schematic illustration of another example of a low-pressure turbine comprising three rotating blade stages, according to the present disclosure.

FIG. 9 is a chart depicting various engine parameters of several exemplary gas turbine engines comprising three rotating blade stages, according to the present disclosure.

FIG. 10 is a cross-sectional schematic illustration of an example of a low-pressure turbine comprising four rotating blade stages, according to the present disclosure.

FIG. 11 is a cross-sectional schematic illustration of another example of a low-pressure turbine comprising four rotating blade stages, according to the present disclosure.

FIG. 12 is a chart depicting various engine parameters of several exemplary gas turbine engines comprising four rotating blade stages, according to the present disclosure.

FIG. 13 is a chart depicting various engine parameters of several exemplary gas turbine engines comprising four rotating blade stages.

FIG. 14 is a cross-sectional schematic illustration of an example of a low-pressure turbine comprising five rotating blade stages, according to the present disclosure.

FIG. 15 is a cross-sectional schematic illustration of another example of a low-pressure turbine comprising five rotating blade stages, according to the present disclosure.

FIG. 16 is a chart depicting various engine parameters of several exemplary gas turbine engines comprising five rotating blade stages, according to the present disclosure.

FIG. 17 is a cross-sectional schematic illustration of an example of a gearbox configuration for a gas turbine engine, according to the present disclosure.

FIG. 18 is a cross-sectional schematic illustration of an example of a gearbox configuration for a gas turbine engine, according to the present disclosure.

FIG. 19 is a cross-sectional schematic illustration of an example of a gearbox configuration for a gas turbine engine, according to the present disclosure.

FIG. 20 is a cross-sectional schematic illustration of an example of a gearbox configuration for a gas turbine engine, according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The term “disk loading” refers to an average pressure change across a plurality of rotor blades of a rotor assembly, such as the average pressure change across a plurality of fan blades of a fan.

As used herein, the term “rated speed” with reference to a gas turbine engine refers to a maximum rated speed of the gas turbine engine. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “cruise operating mode” (or “cruise condition”) refers to the condition of a gas turbine engine utilized to power an aircraft while operating at a cruise speed when the aircraft levels after climbing to a specified altitude associated with cruise flight. A gas turbine engine may operate at a cruise speed that is from 50% to 90% of a rated speed, such as from 70% to 80% of the rated speed. As used herein, the term “cruise flight” refers to a phase of flight in which an aircraft levels in altitude after a climb phase and prior to descending to an approach phase. In most flight envelopes, the cruise operating mode is exemplified by the operating mode of the gas turbine engine at a midpoint of the particular flight envelope based on a total fuel burn for the flight envelope (i.e., when the gas turbine engine has burned 50% of the total fuel burn for that gas turbine engine during the flight operation).

In various examples, cruise flight may take place at a cruise altitude up to approximately 65,000 feet (ft.). In certain examples, cruise altitude is between approximately 28,000 ft. and approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. It should be appreciated that, in certain examples, the ranges of cruise altitude defined by pressure may be adjusted based on a different reference sea-level pressure and/or sea-level temperature.

The term “thrust rating” for a gas turbine engine refers to a maximum amount of thrust the gas turbine engine can generate when operating at the rated speed during standard day operating conditions (i.e., sea level under standard temperature and pressure conditions).

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

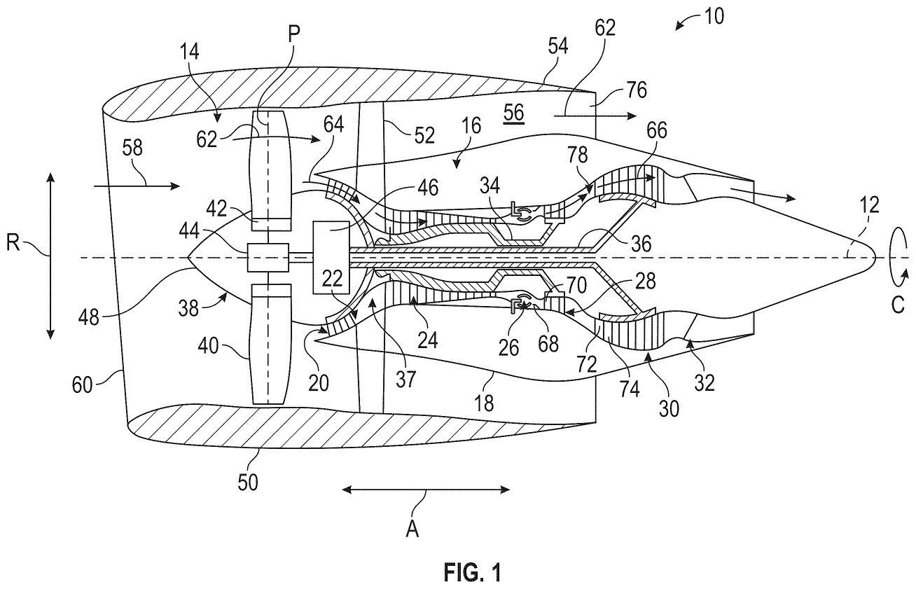

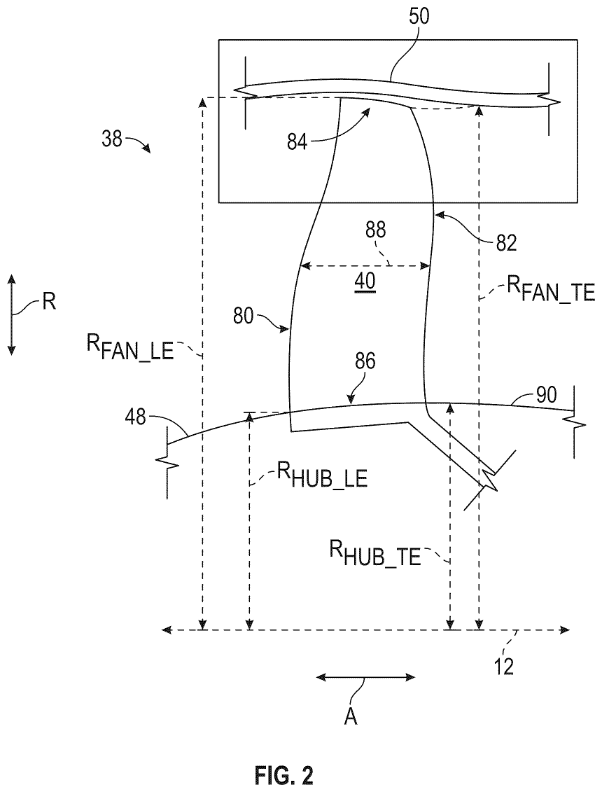

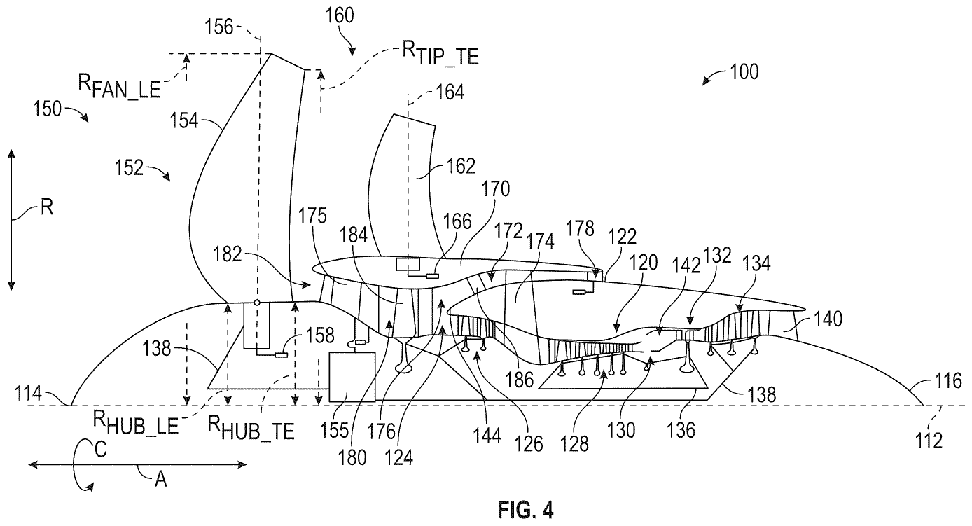

The term “bypass passage” refers generally to a passage with an airflow from a fan of the gas turbine engine that flows over an upstream-most ducted inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 1 and 2). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIG. 4), defined at least in part by a primary fan outer fan area, which refers to an area defined by an annulus representing a portion of the fan located outward of an inlet splitter at the upstream-most inlet to the turbomachine (e.g., inlet splitter of the fan cowl 170 in the embodiment of FIG. 4). An airflow through the bypass passage of a ducted or an unducted engine refers to all of the airflow from the fan that is not provided through the upstream-most inlet to the turbomachine.

The term “bypass ratio” refers to a ratio in a gas turbine engine of a mass flowrate of an airflow from a primary fan through a bypass passage to a mass flowrate of an airflow that passes through the engine's upstream-most ducted inlet. For example, in the embodiment of FIGS. 1, and 4 discussed below, the bypass ratio refers to a mass flowrate of an airflow through the bypass passage (e.g., from a fan 38, 152 that flows over an outer casing 18 or a fan cowl 170) to a mass flowrate of an airflow from the fan 38, 152 that flows through the engine inlet 20, 182. The bypass ratio may be defined during operation of the gas turbine engine in a cruise operating mode.

As used herein, the term “composite material” refers to a material produced from two or more constituent materials, wherein at least one of the constituent materials is a non-metallic material. A composite material is made by combining two or more distinct materials having a finite interface between them. The two or more distinct materials have different chemical and physical properties in relation to one another. One of the two or more distinct materials is the reinforcement (or reinforcing phase), while the other of the two or more distinct materials is the matrix phase. Example composite materials include polymer matrix composites (PMC), ceramic matrix composites (CMC), and metal matrix composites (MMC).

As used herein, polymer matrix composites or “PMC” refers to a class of materials that include a polymer resin matrix and fibers that are stronger than the matrix, stiffer than the matrix, or both. The fibers may be a variety of materials, nonlimiting examples of which include carbon (e.g., graphite) fibers, glass (e.g., fiberglass) fibers, polymer (e.g., Kevlar®) fibers, basalt fibers, ceramic fibers (e.g. silicon carbide or alumina) and metal fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), polyesters, vinylesters, phenolics, and polyimide resins.

PMC materials are produced in various forms for different types for manufacturing. PMC manufacturing may be generally classified into two types: (1) prepreg layup where the operators start with materials where the fibers are preimpregnated with resin usually in thin layers which may be placed in a mold and cured to form the part; and (2) infusion where dry fibers are assembled into a preform shape and resin is infused or injected into the dry preform. There are also many subvariants of these two approaches.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cure to the make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure. As will be appreciated, these are all examples and non-limiting.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al2O3), silicon dioxide (SiO2), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al2O3), silicon dioxide (SiO2), aluminosilicates such as mullite, or mixtures thereof), or mixtures thereof.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. With a gas turbine engine gas turbine engine, and in particular with a high-bypass gas turbine engine, the gas turbine engine further defines a bypass ratio characterizing a ratio of a mass flowrate of airflow over the turbomachine to a mass flowrate of airflow through the working gas flowpath (more particularly defined above).

In order to provide high levels of thrust in a relatively efficient manner, certain gas turbine engines includes a relatively large fan. The inventors of the present disclosure sought out to design a gas turbine engine with a fan having an increased efficiency for a desired overall thrust output of the gas turbine engine.

Conventionally, fan blades are formed of a metal material, which generally provides for desirably thin and light fan blades. In some designs, the thickness of the fan blades drives a hub radius for the fan, which in turn affects an overall size of the fan, as a larger hub radius leads to a larger fan radius for a given thrust design point. While forming the fan blades out of metal is a cost effective manufacturing method that is widely used, the inventors found that a size of the fan blades may be limited with such construction due to the mechanical properties of the metal being used.

In particular, the inventors found that by forming fan blades of the fan out of a composite material, a size of the fan blades could be increased (both in radial length and chord length), as the composite material provides improved strength characteristics over certain metal materials traditionally used for fan blade design. This increase in size, the inventors found, allowed for a reduced fan pressure ratio for a given thrust design point of the gas turbine engine. More specifically, by forming the fan blades out of the composite material, the inventors designed the fan to have a lower solidity and lower fan blade count for the given thrust design point of the gas turbine engine as a result of the increased size of the fan blades.

Conventional design has indicated against such a change in fan blade composition, as forming the fan blades out of composite materials generally results in thicker fan blades, which can be challenging at the hub. However, the inventors found that the lower solidity and lower fan blade count allowed for the fan designed by the inventors to unexpectedly have a lower hub radius (particularly at the leading edge of the fan blades), improving efficiency of the fan at the hub, and allowing for overall shorter fan blades as the fan blades can “start” at a closer radial distance to a centerline of the gas turbine engine.

Further, the inventors of the present disclosure found that by including a reduction gearbox, a rotational speed of the fan may be reduced, further reducing the fan pressure ratio of the fan. While slowing the fan blades down too much can result in a stall at the fan during certain operations, by increasing the size of the fan blades, as is allowed through use of the composite fan blades, the inventors found that the fan may still provide for the desired mass flowrate of airflow thereacross to provide the desired thrust output.

In particular, the inventors discovered, unexpectedly, in the course of designing a gas turbine engine having a fan with composite fan blades, that the costs associated with inclusion of a fan with composite fan blades can be overcome by the aeronautical efficiency benefits to the fan in at least certain designs, contrary to previous thinking and expectations. In particular, the inventors discovered during the course of designing several gas turbine engines having fans with composite fan blades of varying thrust classes and aeronautical efficiency requirements (including the configurations illustrated and described in detail herein), a relationship exists among a leading edge tip radius of a fan blade of the fan, a leading edge hub radius of the fan, a trailing edge tip radius of the fan blade of the fan, and a trailing edge hub radius of the fan, whereby including a fan with composite fan blades in accordance with one or more of the exemplary aspects described herein may result in a net benefit to the overall gas turbine engine design. Notably, the leading edge and trailing edge hub radii (for given leading edge and trailing edge tip radii) are driven by, and correlate to, a solidity and fan blade count of the fan, as lower leading edge and trailing edge hub radii (for given leading edge and trailing edge tip radii) require a fan with a lower solidity and a lower fan blade count.

As briefly noted above, previous thinking was to form fan blades out of metal which avoids the costly process of manufacturing components using composite materials. Manufacturing components out of composite materials is either very labor intensive or requires significant upfront automation design costs. The inventors unexpectedly found that by forming the fan blades out of a composite material, the updated designs of the fan that are enabled result in gas turbine engines with aeronautical efficiency improvements that outweighed the challenges associated with manufacturing the fan blades using composite materials.

In particular, with a goal of arriving at an improved gas turbine engine capable of providing an improved aeronautical efficiency, the inventors proceeded in the manner of designing gas turbine engines having a fan (with composite fan blades) with various leading edge tip radii, leading edge hub radii, trailing edge tip radii, and trailing edge hub radii; checking an operability and aeronautical efficiency characteristics of the designed gas turbine engines; redesigning the gas turbine engines to vary the noted parameters based on the impact on other aspects of the gas turbine engines; rechecking the operability and aeronautical efficiency characteristics of the redesigned gas turbine engines; etc. during the design of several different types of fans with composite fan blades, including the fans with composite fan blades described herein, which are described below in greater detail.

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have other configurations. For example, although the gas turbine engine 10 depicted is configured as a ducted gas turbine engine (i.e., including the outer nacelle 50, also referred to herein as a turbofan engine), in other embodiments, the gas turbine engine 10 may be an unducted gas turbine engine (such that the fan 38 is an unducted fan, and the outlet guide vanes 52 are cantilevered from the outer casing 18; see, e.g., FIG. 4; also referred to herein as an open rotor engine). Additionally, or alternatively, although the gas turbine engine 10 depicted is configured as a variable pitch gas turbine engine (i.e., including a fan 38 configured as a variable pitch fan), in other embodiments, the gas turbine engine 10 may alternatively be configured as a fixed pitch gas turbine engine (such that the fan 38 includes fan blades 40 that are not rotatable about a pitch axis P).

Referring now to FIG. 2, a close-up view is provided of the fan 38 of the gas turbine engine 10 of FIG. 1, and in particular of a fan blade 40 of the fan 38 of the gas turbine engine 10 of FIG. 1. The fan blade 40 generally defines a leading edge 80, a trailing edge 82, an outer tip 84 along the radial direction R, a base 86 along the radial direction R, and a chord 88 from the leading edge 80 to the trailing edge 82.

Further, it will be appreciated that the fan 38 defines a leading edge (LE) fan radius RFan_LE of the fan blade 40, a trailing edge (TE) fan radius RFan_TE of the fan blade 40, a leading edge hub radius RHub_LE of the fan 38, and a trailing edge hub radius RHub_TE of the fan 38. The leading edge fan radius RFan_LE of the fan blade 40 is a measure along the radial direction R from the longitudinal centerline 12 of the gas turbine engine 10 to the outer tip 84 of the fan blade 40 at the leading edge 80. The trailing edge fan radius RFan_TE of the fan blade 40 is a measure along the radial direction R from the longitudinal centerline 12 of the gas turbine engine 10 to the outer tip 84 of the fan blade 40 at the trailing edge 82. The leading edge hub radius RHub_LE of the fan 38 is a measure along the radial direction R from the longitudinal centerline 12 of the gas turbine engine 10 to the base 86 of the fan blade 40 at the leading edge 80 (where the leading edge 80 meets the spinner/front hub 48). The trailing edge hub radius RHub_TE of the fan 38 is a measure along the radial direction R from the longitudinal centerline 12 of the gas turbine engine 10 to the base 86 of the fan blade 40 at the trailing edge 82 (where the trailing edge 82 meets a casing 90 defining in part an airflow path to receive airflow from the fan 38).

Further, it will be appreciated that the fan blade 40 (and each of the fan blades 40 of the fan 38) are formed of a composite material. It will be appreciated that as used herein, the phrase “formed of a composite material,” with reference to the fan blades 40, refers to at least 80% by weight of the fan blades 40, between the base 86 and the outer tip 84, being formed of one or more composite materials.

As alluded to earlier, the inventors discovered, unexpectedly during the course of designing gas turbine engines having a fan with composite fan blades—i.e., designing gas turbine engines having a fan (with composite fan blades) with various leading edge tip radii, leading edge hub radii, trailing edge tip radii, and trailing edge hub radii, and evaluating an overall engine and aeronautical efficiency performance-a significant relationship between the leading edge tip radii, leading edge hub radii, trailing edge tip radii, and trailing edge hub radii. The relationship can be thought of as an indicator of the ability of a gas turbine engine having a fan with composite fan blades to be able to provide a desired aeronautical efficiency for a given level of desired thrust output for the gas turbine engine. As will be appreciated, and as discussed above, the leading edge and trailing edge hub radii (for given leading edge and trailing edge tip radii) are driven by, and correlate to, a solidity and fan blade count of the fan, enabled by the formation of the fan blades out of composite materials, as lower leading edge and trailing edge hub radii (for given leading edge and trailing edge tip radii) require a fan with a lower solidity and a lower fan blade count.

The relationship applies to a gas turbine engine having a reduction gearbox to reduce a rotational speed of the fan relative to a driving turbine of a turbomachine of the gas turbine engine, a fan having fan blades formed of a composite material, and a high bypass ratio (i.e., a bypass ratio greater than or equal to 10). The relationship ties together a leading edge tip radius of a fan blade of the fan, a leading edge hub radius of the fan, a trailing edge tip radius of the fan blade of the fan, and a trailing edge hub radius of the fan, as described in more detail herein.

In particular, the inventors discovered that when designing a gas turbine engine, inclusion of a fan having fan blades with a large leading edge tip radius, the fan pressure ratio and rotational speed of the fan may be decreased, resulting generally in more efficiency. However, to avoid stall and generate a desired thrust output, a chord of the fan blades needs to be increased to ensure a sufficient airflow is provided through the fan. As the chord of the fan blade increases, the trailing edge tip radius of the fan blades may also increase to achieve a desired fan pressure ratio. Notably, however, the inventors found that increasing the leading edge tip radius too much resulted in increased weight and drag, offsetting the aerodynamic benefits otherwise achieved.

Further, with the chords of the fan blades increasing, the inventors of the present disclosure found that the solidity and fan blade count of the fan may be reduced, which may in turn result in lower leading edge and trailing edge hub radii (despite an increase in individual fan blade thickness as a result of forming the fan blades with composite materials). However, the inventors of the present disclosure found that the trailing edge hub radii could not be reduced too much without negatively affecting aerodynamics of an airflow into an inlet to the turbomachine, and the leading edge hub radii could not deviate too much from the trailing edge hub radii without negatively affecting a fan pressure ratio of the fan.

The relationship discovered, infra, can therefore identify a gas turbine engine having a fan having fan blades formed of a composite material, a reduction gearbox, and a high bypass ratio capable of achieving a desired aeronautical efficiency, while avoiding a prohibitive drag and weight increases, aerodynamic penalties, or combinations thereof and suited for particular mission requirements, one that takes into account efficiency, weight, structural needs for the fan blades, complexity, reliability, and other factors influencing the optimal choice for a gas turbine engine having a fan having fan blades formed of a composite material, a reduction gearbox, and a high bypass ratio.

In addition to yielding an improved gas turbine engine as noted above, utilizing this relationship, the inventors found that the number of suitable or feasible gas turbine engine designs capable of meeting the above design requirements could be greatly diminished, which facilitates a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

One such relationship providing for improved gas turbine engines, discovered by the inventors, is a Fan Leading Edge to Trailing Edge Compression Factor (FLTCF), expressed as:

$$F L T C F = \frac{{R}_{Fan \_ LE} \times {R}_{Hub \_ TE}}{{R}_{Fan \_ TE} \times {R}_{Hub \_ LE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

Another such relationship providing for the improved gas turbine engines, discovered by the inventors, is a Fan Leading Edge to Trailing Edge Opening Ratio (FLTOR), expressed as:

$$F L T O R = \frac{{R}_{Fan \_ LE} - {R}_{Hub \_ LE}}{{R}_{Fan \_ TE} - {R}_{Hub \_ TE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

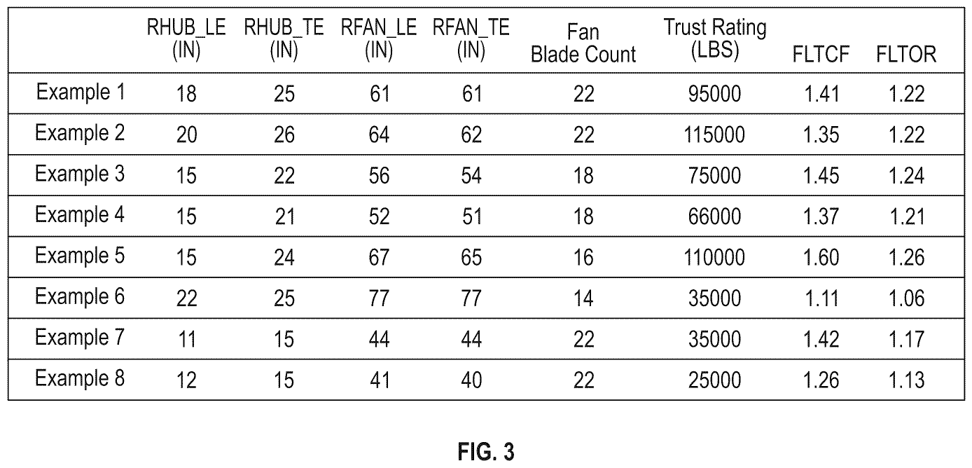

Example engines in accordance with one or more exemplary embodiments of the present disclosure are provided in the table of FIG. 3. The FLTCF is valid only when it is greater than or equal to 1.05 and less than or equal to 1.8. For example, in certain exemplary embodiments, the FLTCF is greater than or equal to 1.07 and less than or equal to 1.65. Further, the FLTOR is valid only when it is greater than or equal to 1.03 and less than or equal to 1.5. For example, in certain exemplary embodiments, the FLTOR is greater than or equal to 1.05 and less than or equal to 1.3. These and other aspects of FLTCF and FLTOR in which these relationships are valid are set forth below in Table 1. FLTCF and FLTOR are not valid outside of the ranges in Table 1.

TABLE 1

| Symbol | Description | FLTCP, FLTOR |
|---|---|---|
| R_{Fan}_LE | Leading edge fan radius of | 20 inches to 85 inches, such |
| | a fan blade of a fan of a gas | as 35 inches to 80 inches |
| | turbine engine | |
| R_{Fan}_TE | Trailing edge fan radius of the | 20 inches to 85 inches, such |
| | fan blade of the fan of the gas | as 35 inches to 68 inches |
| | turbine engine | |
| R_{Hub}_LE | Leading edge hub radius of the | 5 inches to 30 inches, such as |
| | fan of the gas turbine engine | 6 inches to 25 inches |
| R_{Hub}_TE | Trailing edge hub radius of the | 5 inches to 30 inches, such as |
| | fan of the gas turbine engine | 6 inches to 25 inches |
| FLTCF | Fan Leading Edge to Trailing | 1.05 to 1.8, such as 1.07 to |
| | Edge Compression Factor | 1.65 |
| FLTOR | Fan Leading Edge to Trailing | 1.03 to 1.5, such as 1.05 to |
| | Edge Opening Ratio | 1.3 |

Notably, each of exemplary engines noted in FIG. 3 defines a bypass ratio greater than or equal to 10 and less than or equal to 100, such as greater than or equal to 13, such as greater than or equal to 15, and less than or equal to 85, such as less than or equal to 70, such as less than or equal to 25. Further, each of the exemplary engines noted in FIG. 3 includes a reduction gearbox (and thus may be referred to as a geared gas turbine engine) defining a gear ratio greater than or equal to 2 and less than or equal to 14.

For example, in one exemplary embodiment, the gas turbine engine may be an unducted gas turbine engine (also referred to as an “open rotor engine”) including an unducted fan having fan blades formed of a composite material (see, e.g., the embodiment of FIG. 4, described below). In such an exemplary embodiment, a leading edge fan radius R_{Fan_LE} of a fan blade of the fan is greater than or equal to 65 inches and less than or equal to 85 inches, the fan defines a fan blade count greater than or equal to 5 and less than or equal to 15, a reduction gearbox defines a gear ratio greater than 4 and less than 12, and a thrust rating for the engine is between 20,000 pounds and 45,000 pounds. With such an exemplary embodiment the FLTCF is greater than or equal to 1.07 and less than or equal to 1.25, and the FLTOR is greater than or equal to 1.03 and less than or equal to 1.12. In such a manner, it will be appreciated that forming the fan blades of a composite material with this exemplary gas turbine engine enabled a size of the fan (both radially and in a chordwise direction) to be increased, allowing for a desired thrust output, despite a reduction in the fan blade count of the fan and solidity of the fan blades. Example 6 in FIG. 3 is an exemplary embodiment of such a gas turbine engine.

Further for example, in another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 35 inches and less than or equal to 50 inches, the fan defines a fan blade count greater than or equal to 12 and less than or equal to 23, a reduction gearbox defines a gear ratio greater than 2 and less than 4, and a thrust rating for the engine is between 20,000 pounds and 45,000 pounds. With such an exemplary embodiment the FLTCF is greater than or equal to 1.12 and less than or equal to 1.35, and the FLTOR is greater than or equal to 1.06 and less than or equal to 1.19. In such a manner, it will be appreciated that forming the fan blades of a composite material with this exemplary gas turbine engine enabled a size of the fan (e.g., in a chordwise direction) to be increased, allowing for a desired thrust output, despite a potential reduction in the fan blade count of the fan and solidity of the fan blades. Example 8 in FIG. 3 is an exemplary embodiment of such a gas turbine engine.

For example, in yet another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 51 inches and less than or equal to 66 inches, the fan defines a fan blade count greater than or equal to 17 and less than or equal to 23, a reduction gearbox defines a gear ratio greater than 1 and less than 4, and a thrust rating for the engine is between 60,000 pounds and 118,000 pounds. With such an exemplary embodiment the FLTCF is greater than or equal to 1.27 and less than or equal to 1.5, and the FLTOR is greater than or equal to 1.18 and less than or equal to 1.25. In such a manner, it will be appreciated that forming the fan blades of a composite material with this exemplary gas turbine engine enabled a size of the fan (e.g., in a radial direction and in a chordwise direction) to be increased, allowing for a desired thrust output, despite a potential reduction in the fan blade count of the fan and solidity of the fan blades. Examples 1 through 4 in FIG. 3 are exemplary embodiments of such a gas turbine engine.

Further for example, in still another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 55 inches and less than or equal to 70 inches, the fan defines a fan blade count greater than or equal to 12 and less than or equal to 22 (e.g., less than or equal to 19), a reduction gearbox defines a gear ratio greater than 1 and less than 4, and a thrust rating for the engine is between 100,000 pounds and 150,000 pounds (such as greater than 118,000 pounds and less than 150,000 pounds). With such an exemplary embodiment the FLTCF is greater than or equal to 1.46 and less than or equal to 1.65, and the FLTOR is greater than or equal to 1.2 and less than or equal to 1.5 (such as greater than or equal to 1.25 and less than 1.5). In such a manner, it will be appreciated that forming the fan blades of a composite material have enabled a size of the fan (e.g., in a radial direction and in a chordwise direction) to be increased, allowing for a desired thrust output, despite a potential reduction in the fan blade count of the fan and solidity of the fan blades. Example 5 in FIG. 3 is an exemplary embodiments of such a gas turbine engine.

Referring now to FIG. 4, a schematic cross-sectional view of a gas turbine engine 100 is provided according to another example embodiment of the present disclosure. The exemplary gas turbine engine 100 of FIG. 4 may be configured in substantially the same manner as the exemplary gas turbine engine 100 described above with reference to FIGS. 1 and 2.

For example, the exemplary gas turbine engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

Further, the exemplary gas turbine engine 100 generally includes a fan section 150 and a turbomachine 120. Generally, the turbomachine 120 includes, in serial flow order, a compressor section, a combustion section, a turbine section, and an exhaust section. Particularly, as shown in FIG. 4, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126; a high pressure (“HP”) compressor 128; a combustor 130; a high pressure turbine 132; and a low pressure turbine 134. The high pressure turbine 128 drives the high pressure compressor 128 through a high pressure shaft 136. The low pressure turbine 134 drives the low pressure compressor 126 and components of the fan section 150 through a low pressure shaft 138, and as such may be referred to as a drive turbine. After driving each of the turbines 132, 134, combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. By contrast to the embodiment of FIG. 1, for the depicted embodiment of FIG. 4, the fan 152 is an open rotor or unducted fan 152. In such a manner, the gas turbine engine 100 may be referred to as an open rotor engine.

As depicted, the fan 152 includes an array of fan blades 154 (only one shown in FIG. 4). The fan blades 154 are rotatable, e.g., about the longitudinal axis 112. As noted above, the fan 152 is drivingly coupled with the low pressure turbine 134 via the LP shaft 138. As with the exemplary embodiments discussed above, the fan blades 154 are formed of a composite material.

Further for the embodiments shown in FIG. 4, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170.

By contrast to the embodiment of FIG. 1, as shown in FIG. 4, in addition to the unducted fan 152, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 4). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 186 may be positioned in thermal communication with the fan duct 172. For example, one or more heat exchangers 186 may be disposed within the fan duct 172 and utilized to cool one or more fluids from the core engine with the air passing through the fan duct 172, as a resource for removing heat from a fluid, e.g., compressor bleed air, oil or fuel.

Although not depicted in the example of FIG. 4, the heat exchanger 186 may be an annular heat exchanger extending substantially 360 degrees in the fan duct 172 (e.g., at least 300 degrees, such as at least 330 degrees). In such a manner, the heat exchanger 186 may effectively utilize the air passing through the fan duct 172 to cool one or more systems of the engine 100 (e.g., lubrication oil systems, compressor bleed air, electrical components, etc.). The heat exchanger 186 uses the air passing through duct 172 as a heat sink and correspondingly increases the temperature of the air downstream of the heat exchanger 186 and exiting the fan exhaust nozzle 178.

As will be appreciated from the description herein, various other embodiments of a gas turbine engine are provided. Certain of these embodiments may be an unducted, single rotor gas turbine engine, or a ducted gas turbine engine. Various additional aspects of one or more of these embodiments are discussed below. These exemplary aspects may be combined with one or more of the exemplary gas turbine engine(s) discussed above with respect to the figures.

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 pounds per square inch absolute (psia) and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics and provide the benefits noted herein associated with forming the fan blades from a composite material, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is greater than or equal to 2. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

The combination of the fan geometric relationships described herein—namely, the Fan Leading Edge to Trailing Edge Compression Factor (FLTCF) and the Fan Leading Edge to Trailing Edge Opening Ratio (FLTOR)—with the defined drive turbine area ratio and area-Exhaust Gas Temperature (area-EGT) ratio provides synergistic aerodynamic and structural advantages in a geared gas turbine engine. The FLTCF and FLTOR parameters coordinate the leading and trailing edge tip and hub radii of the fan blades to maintain a desired fan pressure ratio and mass flow capability while limiting excessive hub growth, blade solidity, and associated weight. In this manner, a fan utilizing the disclosed technology may operate at a relatively lower rotational speed and pressure ratio, thereby improving propulsive efficiency and reducing aerodynamic losses, while maintaining acceptable inlet flow characteristics and avoiding undesirable increases in drag or structural mass.

When such a fan architecture is mechanically coupled to a drive turbine through a reduction gearbox, the defined drive turbine area ratio and area-EGT ratio enable improved thermodynamic and mechanical matching between the turbine and the fan. The area ratio, defined as the ratio of the annular exit area of the aft-most rotating stage to that of the forward-most rotating stage, governs the distribution of expansion and stage loading through the turbine. Constraining this ratio within the disclosed ranges promotes efficient extraction of work across a limited number of rotating stages, such as three or four stages, thereby reducing turbine length and weight while maintaining desired power output. The area-EGT ratio further correlates turbine flow capacity and stage count with exhaust gas temperature at a redline operating condition, ensuring that the turbine is neither over-expanded nor thermally overburdened for a given engine cycle.

By integrating the disclosed fan and turbine parameters within a single engine architecture, the engine achieves improved overall efficiency and structural balance. The fan geometry defined by the FLTCF and FLTOR reduces rotating mass and bending loads, while the controlled LPT area ratio and area-EGT ratio promote compact turbine architecture and appropriate thermal loading. Because the gearbox mechanically couples a higher-speed turbine to a lower-speed fan, proper aerodynamic and thermodynamic matching between these components reduces torsional stresses, bearing loads, and off-design penalties. The resulting gas turbine engine therefore exhibits improved specific fuel consumption, reduced weight, and enhanced structural integrity relative to conventional configurations lacking such coordinated parameter relationships.

The disclosed area ratio ranges and/or the area-EGT ratio ranges disclosed herein provide a gas turbine engine with improved performance and efficiency, as discussed further below.

The low-pressure turbines disclosed herein comprise 3-4 rotating stages and an area ratio within a range of 2.0-6.5. Low-pressure turbines comprising 3-4 stages and an area ratio within a range of 2.0-5.1 or 2.0-3.0 are particularly advantageous.

Each rotating stage of the low-pressure turbine comprises an annular exit area defined by a tip radius of a trailing edge of any one blade of the rotating stage and a hub radius of the any one blade of the rotating stage at an axial location aligned with the tip radius. The area ratio equals the annular exit area of an aft-most rotating stage of the low-pressure turbine divided by the annular exit area of a forward-most rotating stage of the low-pressure turbine.

The low-pressure turbines disclosed herein additionally comprise an area-EGT ratio within a range of 1.06-1.6, 1.2-1.6, 1.2-1.3, 1.25-1.35, 1.3-1.6. The area-EGT

$$ratio = \frac{{( area ratio )}^{( 1 / ( stages - 1 ) )}}{( EGT / 1000 )} .$$

Each rotating stage comprises an annular exit area defined by a tip radius of a trailing edge of any one blade of the rotating stage and a hub radius of the any one blade of the rotating stage at an axial location aligned with the tip radius. The area ratio is the annular exit area of an aft-most rotating stage of the low-pressure turbine divided by the annular exit area of a forward-most rotating stage of the low-pressure turbine, wherein the stages is the number of rotating stages of the low-pressure turbine.

The term “redline exhaust gas temperature” (referred to herein as “redline EGT”) refers to a maximum permitted takeoff temperature documented in a Federal Aviation Administration (“FAA”) type certificate data sheet. For example, in certain examples, the term redline EGT may refer to a maximum takeoff temperature of an airflow after a first stage stator downstream of an HP turbine of an engine that the engine is rated to withstand. In other examples, the term redline EGT refers to a maximum temperature of an airflow after the first stator downstream of the last stage of rotor blades of the HP turbine and into the first of the plurality of LP turbine rotor blades 210. The term redline EGT is sometimes also referred to as an indicated turbine temperature.

The term “redline operating condition” refers to the maximum permissible engine rotor operating speed documented in a FFA type certificate data sheet. In certain examples, the FFA type certificate may provide a redline operating condition as the maximum permissible engine rotor speed for the low-pressure rotor (N1) and/or high-pressure rotor (N2) stated in revolutions per minute (rpm).

In some examples, a gas turbine engine includes a fan assembly, a low-pressure turbine, and a gearbox. The fan assembly includes a plurality of fan blades. The low-pressure turbine includes 3-4 rotating stages. Each rotating stage of the low-pressure turbine includes an annular exit area defined by a tip radius of a trailing edge of any one blade of the rotating stage and a hub radius of the any one blade of the rotating stage at an axial location aligned with the tip radius. The low-pressure turbine includes an area ratio equal to the annular exit area of an aft-most rotating stage of the low-pressure turbine divided by the annular exit area of a forward-most rotating stage of the low-pressure turbine, and the area ratio is within a range of 2.0-5.1. The gearbox includes an input and an output. The input of the gearbox is coupled to the low-pressure turbine and includes a first rotational speed, and the output of the gearbox is coupled to the fan assembly and has a second rotational speed.

In some examples, the area ratio of the low-pressure turbine is within a range of 2.2-2.6.

In some examples, the area ratio of the low-pressure turbine is within a range of 2.0-3.5.

In some instances, the low-pressure turbine includes exactly three rotating stages and/or the area ratio of the low-pressure turbine is within a range of 2.2-3.0.

In some instances, the low-pressure turbine includes exactly four rotating stages, and/or the area ratio of the low-pressure turbine is within a range of 2.0-5.1, or 2.3-3.3, or 2.3-2.6, or 2.3-2.9.

In some examples, a gas turbine engine includes a fan assembly, a low-pressure turbine, and a gearbox. The fan assembly includes a plurality of fan blades. The low-pressure turbine comprising 3-4 rotating stages. Each rotating stage of the low-pressure turbine comprises an annular exit area defined by a tip radius of a trailing edge of any one blade of the rotating stage and a hub radius of the any one blade of the rotating stage at an axial location aligned with the tip radius. The low-pressure turbine comprises an area ratio equal to the annular exit area of an aft-most rotating stage of the low-pressure turbine divided by the annular exit area of a forward-most rotating stage of the low-pressure turbine, and the area ratio is within a range of 2.0-4.6 (or 2.0-3.5 or 2.25-2.6). The gearbox including an input and an output. The input of the gearbox is coupled to the low-pressure turbine and comprises a first rotational speed, the output of the gearbox is coupled to the fan assembly and has a second rotational speed, and a gear ratio of the first rotational speed to the second rotational speed is within a range of 3.0-3.5.

In some examples, a gas turbine engine comprising a fan assembly, a low-pressure turbine, and a gearbox. The fan assembly including a plurality of fan blades. The low-pressure turbine comprises 3-4 rotating stages and an area-EGT ratio within a range of 1.05-1.6. The area-EGT

$$ratio = \frac{{( area ratio )}^{( 1 / ( LPT stages - 1 ) )}}{( EGT / 1000 )} .$$

Each rotating stage of the low-pressure turbine comprises an annular exit area defined by a tip radius of a trailing edge of any one blade of the rotating stage and a hub radius of the any one blade of the rotating stage at an axial location aligned with the tip radius. The area ratio is the annular exit area of an aft-most rotating stage of the low-pressure turbine divided by the annular exit area of a forward-most rotating stage of the low-pressure turbine. The LPT stages is the number of rotating stages of the low-pressure turbine. The EGT is an exhaust gas temperature of the low-pressure turbine measured in degrees Celsius at an inlet of the low-pressure turbine at a redline operating condition. The gearbox including an input and an output. The input of the gearbox is coupled to the low-pressure turbine and comprises a first rotational speed, and the output of the gearbox is coupled to the fan assembly and has a second rotational speed.

In some examples, the area-EGT ratio is within a range of 1.05-1.58.

In some examples, the area-EGT ratio is within a range of 1.05-1.53.

In some examples, the area-EGT ratio is within a range of 1.05-1.30.

In some examples, the area-EGT ratio is within a range of 1.20-1.30.

In some examples, the area-EGT ratio is within a range of 1.3-1.6.

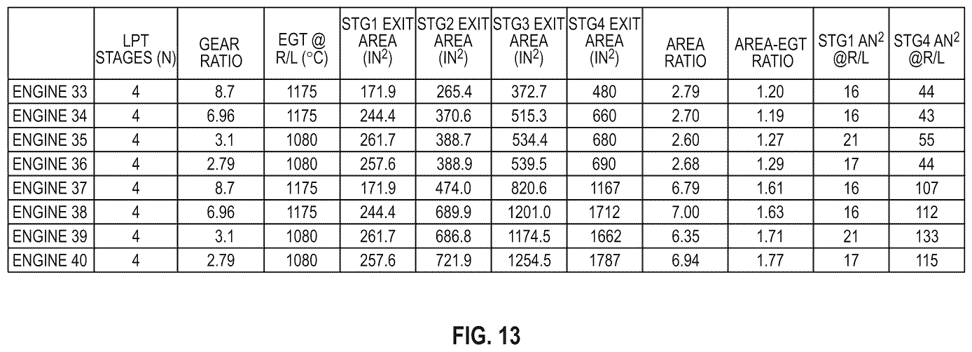

It should be noted that there are some engines described herein (e.g., FIGS. 13-16) that have an area ratio and/or area-EGT ratio outside of the ranges of 2.0-5.1 and 1.05-1.6, respectively. These engines are provided merely for purposes of comparison.

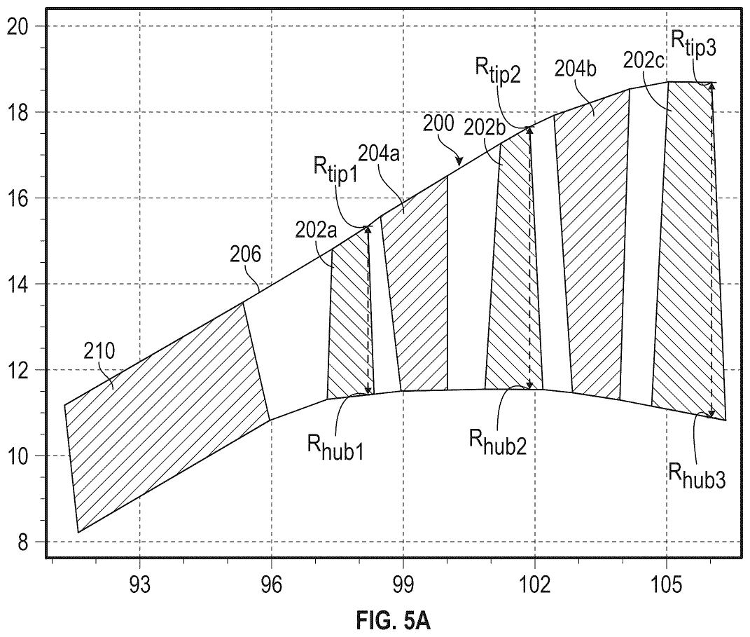

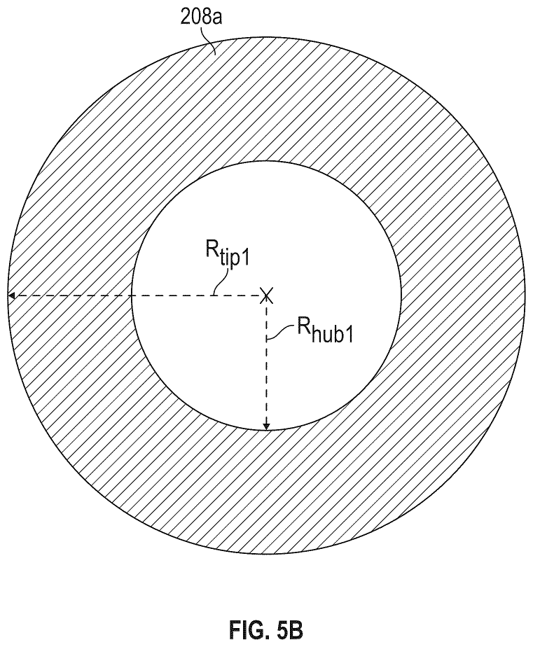

FIG. 5A depicts a portion of a three-stage low-pressure turbine 500, according to one example of the disclosed technology. The low-pressure turbine (LPT) 500 can be used, for example, with any of the gas turbine engines disclosed herein (e.g., the engines 10, 100). The LPT 200 comprises a plurality of rotating blade stages and a plurality of stationary vane stages. In particular, the depicted portion of the LPT 200 comprises three rotating blade stages 202a, 202b, and 202c and two stationary vane stages 204a and 204b. The rotating blade stages are referred to herein generically or collectively as “a/the rotating blade stage(s) 202” or simply “the blades 202,” and the stationary vane stages are referred to herein generically or collectively as “a/the stationary vane stage(s) 204” or simply “the vanes 204.”

The blades 202 and the vanes 204 are disposed within a duct 206, which guides the fluid flow through the LPT 200.

Each rotating blade stage 202 of the LPT 200 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect shrouded turbine blades, the tip radius is the radius at the tip of the blade portion, excluding the shroud portion.

For example, the forward-most rotating blade stage (which can also be referred to as “the first stage”) 202a of the LPT 200 comprises an annular exit area 208a, as depicted in FIG. 5B. The annular exit area 208a is defined by the tip radius Rₜᵢₚ₁ and hub radius R_{hub1}. Rₜᵢₚ₁ is the tip radius of the trailing edge of any blade of the first stage 202a (or a nominal tip radius of the trailing edges of the blades of the first stage 202a), and R_{hub1} is the hub radius of the blade (or a nominal hub radius of the blades of the first stage) at the axial location aligned with the tip radius Rₜᵢₚ₁.

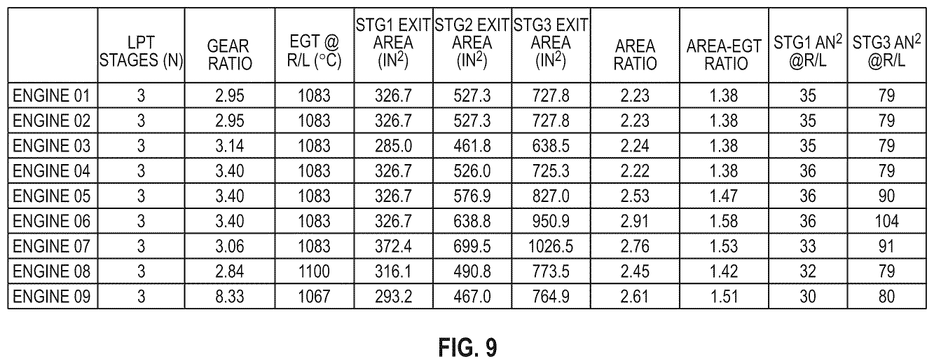

In some examples, the annular exit area of the first stage 202a can be within a range of 155-380 in² or within a range of 155-372 in². In particular examples, the annular exit area can be within a range of 280-380 in² or within a range of 285-372 in². In the depicted example, the annular exit area 208a of the first stage 202a is about 327 in². Additional examples of annular exit areas for the first stage of a three-stage low-pressure turbine are provided in the table depicted in FIG. 9.

As another example, the second stage 202b of the LPT 200 comprises an annular exit area. The annular exit area of the second stage 202b is defined by the tip radius Rₜᵢₚ₂ and hub radius R_{hub2}. Rₜᵢₚ₂ is the tip radius of the trailing edge of any blade of the second stage 202b (or a nominal tip radius of the trailing edges of the blades of the second stage 202b), and R_{hub2} is the hub radius of the blade (or a nominal hub radius of the blades of the second stage 202b) at the axial location aligned with the tip radius Rₜᵢₚ₂.

In some examples, the annular exit area of the second stage 202b can be within a range of 230-750 in² or within a range of 250-700 in². In particular examples, the annular exit area of the second stage 202b can be within a range of 450-750 in² or within a range of 462-699 in². In the depicted example, the annular exit area of the second stage 202b is about 526 in². Additional examples of annular exit areas for the second stage of a three-stage low-pressure turbine are provided in the table depicted in FIG. 9.

As another example, the aft-most stage (which can also be referred to as “the third stage”) 202c of the LPT 200 comprises an annular exit area. The annular exit area of the third stage 202c is defined by the tip radius Rₜᵢₚ₃ and hub radius R_{hub3}. Rₜᵢₚ₃ is the tip radius of the trailing edge of any blade of the third stage 202c (or a nominal tip radius of the trailing edges of the blades of the third stage 202c), and R_{hub3} is the hub radius of the blade (or a nominal hub radius of the blades of the third stage 202c) at the axial location aligned with the tip radius Rₜᵢₚ₃.

In some examples, the annular exit area of the third stage 202c can be within a range of 350-1050 in² or within a range of 379-1027 in². In particular examples, the annular exit area of the third stage 202c can be within a range of 600-1050 in² or within a range of 639-1027 in². In the depicted example, the annular exit area of the third stage 202c is about 725 in². Additional examples of annular exit areas for the third stage of a low-pressure turbine are provided in the table depicted in FIG. 9.

The LPT 200 comprises an area ratio (which can also be referred to as “an exit area ratio”) within a range of 2.0-5.1, within a range of 2.0-3.0, within a range of 2.2-2.91, and specifically about 2.2. The area ratio equals the annular exit area of an aft-most rotating stage of the low-pressure turbine divided by the annular exit area of a forward-most rotating stage of the low-pressure turbine. For example, for the LPT 200, the area ratio equals the annular exit area of the third stage 202c divided by the annular exit area 208a of the first stage 202a.

In addition to having an area ratio within a range of 2.0-5.1, the LPT 200 can comprise an area-exhaust gas temperature (EGT) ratio, referred to herein as area-EGT ratio, within a range of 1.05-1.6, within a range of 1.05-1.3, or within a range of 1.38-1.58, and specifically about 1.38. The area-EGT ratio is defined according to Expression (1):

$$area - EGT ratio = \frac{{( the area ratio )}^{( 1 / ( LPT stages - 1 ) )}}{( EGT / 1000 )} \qquad ( 1 )$$

where the area ratio is as defined above, LPT stages is the number of rotating blade stages of LPT, and EGT is an exhaust gas temperature of the LPT measured in degrees Celsius at an inlet of the LPT at a redline operating condition.

In some examples, the number of LPT stages is 3, 4, or 5. For example, the LPT 200 includes exactly three stages. The table of FIG. 9 provides additional exemplary engines comprising exactly three LPT stages.

In some examples, EGT is within a range of 1060-1180 degrees Celsius measured at the inlet of the LPT at the redline operating condition. For example, the EGT of the LPT 200 is about 1083 degrees Celsius at the redline operating condition. As used herein the inlet of the LPT is defined by the turbine vane frame (TVF). The EGT can be measured at any axial location aligned with the TVF, i.e., from the leading edge to the trailing edge of the TVF. Thus, with respect to the LPT 200, the inlet of the LPT 200 for purposes of measuring EGT is any axial location aligned with a TVF 210.

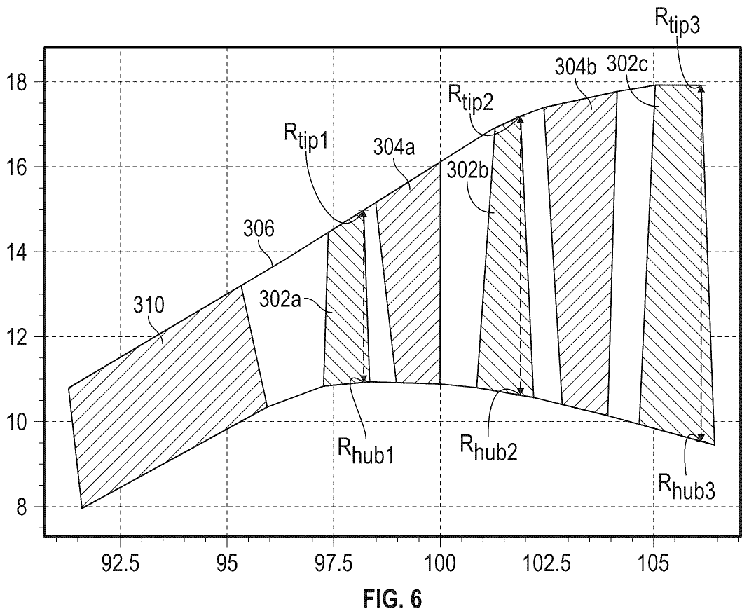

FIG. 6 depicts a portion of a low-pressure turbine 300, according to one example of the disclosed technology. The low-pressure turbine 300 can be used, for example, with any of the gas turbine engines disclosed herein (e.g., the engines 10, 100), and particularly Engine 05 depicted in the table of FIG. 9. The LPT 300 comprises a plurality of rotating blade stages and a plurality of stationary vane stages. In particular, the depicted portion of the LPT 300 comprises three rotating blade stages 302a, 302b, and 302c and two stationary vane stages 304a and 304b. The rotating blade stages are referred to herein generically or collectively as “a/the rotating blade stage(s) 302” or simply “the blades 302,” and the stationary vane stages are referred to herein generically or collectively as “a/the stationary vane stage(s) 304” or simply “the vanes 304.”

The blades 302 and the vanes 304 are disposed within a duct 306 aft of a TVF 310, which guides the fluid flow through the LPT 300.

Each rotating blade stage 302 of the LPT 300 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius.

For example, the forward-most rotating blade stage (which can also be referred to as “the first stage”) 302a of the LPT 300 comprises an annular exit area. The annular exit area is defined by the tip radius Rₜᵢₚ₁ and hub radius R_{hub1}. Rₜᵢₚ₁ is the tip radius of the trailing edge of any blade of the first stage 302a (or a nominal tip radius of the trailing edges of the blades of the first stage 302a), and R_{hub1} is the hub radius of the blade (or a nominal hub radius of the blades of the first stage) at the axial location aligned with the tip radius Rₜᵢₚ₁.

In some examples, the annular exit area of the first stage 302a can be within a range of 155-380 in². In particular examples, the annular exit area can be within a range of 280-380 in² or within a range of 285-372 in². In the depicted example, the annular exit area of the first stage 302a is about 327 in².

As another example, the second stage 302b of the LPT 300 comprises an annular exit area. The annular exit area of the second stage 302b is defined by the tip radius Rₜᵢₚ₂ and hub radius R_{hub2}. Rₜᵢₚ₂ is the tip radius of the trailing edge of any blade of the second stage 302b (or a nominal tip radius of the trailing edges of the blades of the second stage 302b), and R_{hub2} is the hub radius of the blade (or a nominal hub radius of the blades of the second stage 302b) at the axial location aligned with the tip radius Rₜᵢₚ₂.

In some examples, the annular exit area of the second stage 302b can be within a range of 230-750 in² or within a range of 250-700 in². In particular examples, the annular exit area of the second stage 302b can be within a range of 450-750 in² or within a range of 462-699 in². In the depicted example, the annular exit area of the second stage 302b is about 577 in².

As another example, the aft-most stage (which can also be referred to as “the third stage”) 302c of the LPT 300 comprises an annular exit area. The annular exit area of the third stage 302c is defined by the tip radius Rₜᵢₚ₃ and hub radius R_{hub3}. Rₜᵢₚ₃ is the tip radius of the trailing edge of any blade of the third stage 302c (or a nominal tip radius of the trailing edges of the blades of the third stage 302c), and R_{hub3} is the hub radius of the blade (or a nominal hub radius of the blades of the third stage 302c) at the axial location aligned with the tip radius Rₜᵢₚ₃.

In some examples, the annular exit area of the third stage 302c can be within a range of 350-1050 in² or within a range of 379-1027 in². In particular examples, the annular exit area of the third stage 302c can be within a range of 700-1050 in² or within a range of 639-1027 in². In the depicted example, the annular exit area of the third stage 302c is about 827 in².

The LPT 300 comprises an area ratio (which can also be referred to as “an exit area ratio”) within a range of 2.0-5.1, within a range of 2.0-3.0, within a range of 2.2-2.9, and specifically about 2.53. For example, for the LPT 300, the area ratio equals the annular exit area of the third stage 302c divided by the annular exit area of the first stage 302a.

The LPT 300 can also comprise an area-EGT ratio within a range of 1.05-1.6, within a range of 1.35-1.58, and specifically about 1.47.

In some examples, the EGT of the LPT 300 is within a range of 1060-1180 degrees Celsius measured at the inlet of the LPT at the redline operating condition. For example, the LPT 300 comprises an EGT of about 1083 degrees Celsius at the redline operating condition.

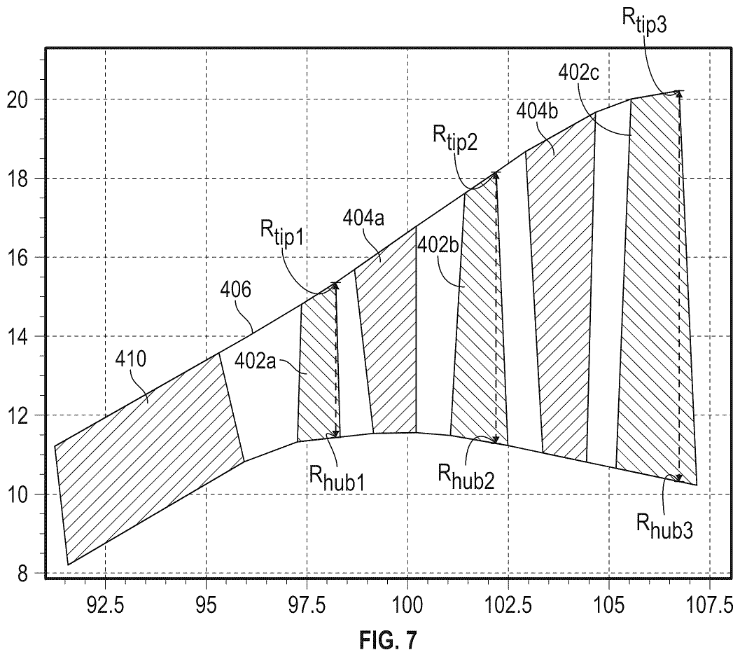

FIG. 7 depicts a portion of a low-pressure turbine 400, according to one example of the disclosed technology. The low-pressure turbine 400 can be used, for example, with any of the gas turbine engines disclosed herein (e.g., the engines 10, 100), and particularly Engine 07 depicted in the table of FIG. 9. The LPT 400 comprises a plurality of rotating blade stages and a plurality of stationary vane stages. In particular, the depicted portion of the LPT 400 comprises three rotating blade stages 402a, 402b, and 402c and two stationary vane stages 404a and 404b. The rotating blade stages are referred to herein generically or collectively as “a/the rotating blade stage(s) 402” or simply “the blades 402,” and the stationary vane stages are referred to herein generically or collectively as “a/the stationary vane stage(s) 404” or simply “the vanes 404.”

The blades 402 and the vanes 404 are disposed within a duct 406 aft of a TVF 410, which guides the fluid flow through the LPT 400.

Each rotating blade stage 402 of the LPT 400 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect shrouded turbine blades, the tip radius is the radius at the tip of the blade portion, excluding the shroud portion.

For example, the forward-most rotating blade stage (which can also be referred to as “the first stage”) 402a of the LPT 400 comprises an annular exit area. The annular exit area is defined by the tip radius Rₜᵢₚ₁ and hub radius R_{hub1}. Rₜᵢₚ₁ is the tip radius of the trailing edge of any blade of the first stage 402a (or a nominal tip radius of the trailing edges of the blades of the first stage 402a), and R_{hub1} is the hub radius of the blade (or a nominal hub radius of the blades of the first stage) at the axial location aligned with the tip radius Rₜᵢₚ₁.

In some examples, the annular exit area of the first stage 402a can be within a range of 155-380 in². In particular examples, the annular exit area can be within a range of 280-380 in². In the depicted example, the annular exit area of the first stage 402a is about 372 in².

As another example, the second stage 402b of the LPT 400 comprises an annular exit area. The annular exit area of the second stage 402b is defined by the tip radius Rₜᵢₚ₂ and hub radius R_{hub2}. Rₜᵢₚ₂ is the tip radius of the trailing edge of any blade of the second stage 402b (or a nominal tip radius of the trailing edges of the blades of the second stage 402b), and R_{hub2} is the hub radius of the blade (or a nominal hub radius of the blades of the second stage 402b) at the axial location aligned with the tip radius Rₜᵢₚ₂.

In some examples, the annular exit area of the second stage 402b can be within a range of 250-710 in². In particular examples, the annular exit area of the second stage 402b can be within a range of 450-700 in². In the depicted example, the annular exit area of the second stage 402b is about 700 in².

As another example, the aft-most stage (which can also be referred to as “the third stage”) 402c of the LPT 400 comprises an annular exit area. The annular exit area of the third stage 402c is defined by the tip radius Rₜᵢₚ₃ and hub radius R_{hub3}. Rₜᵢₚ₃ is the tip radius of the trailing edge of any blade of the third stage 402c (or a nominal tip radius of the trailing edges of the blades of the third stage 402c), and R_{hub3} is the hub radius of the blade (or a nominal hub radius of the blades of the third stage 402c) at the axial location aligned with the tip radius Rₜᵢₚ₃.

In some examples, the annular exit area of the third stage 402c can be within a range of 350-1100 in². In particular examples, the annular exit area of the third stage 402c can be within a range of 380-1050 in² or within a range of 639-1027 in². In the depicted example, the annular exit area of the third stage 402c is about 1027 in².

The LPT 400 comprises an area ratio (which can also be referred to as “an exit area ratio”) within a range of 2.0-5.1, within a range of 2.22-2.91, and specifically about 2.76. For example, for the LPT 400, the area ratio equals the annular exit area of the third stage 402c divided by the annular exit area of the first stage 402a.

The LPT 400 can, additionally or alternatively to the area ratio within a range of 2.0-5.1, comprise an area-EGT ratio within a range of 1.05-1.6, within a range of 1.35-1.55, and specifically 1.53.

In some examples, EGT of the LPT 400 is within a range of 1060-1180 degrees Celsius measured at the inlet of the LPT at the redline operating condition. For example, the LPT 400 comprises an EGT of about 1083 degrees Celsius at the redline operating condition.

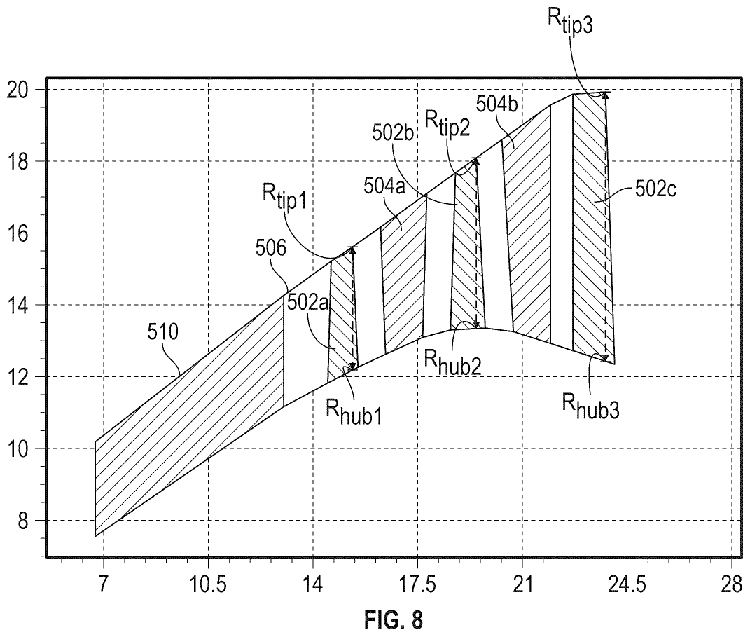

FIG. 8 depicts a portion of a low-pressure turbine 500, according to one example of the disclosed technology. The low-pressure turbine 500 can be used, for example, with any of the gas turbine engines disclosed herein (e.g., the engines 10, 100), and particularly Engine 09 depicted in the table of FIG. 9. The LPT 500 comprises a plurality of rotating blade stages and a plurality of stationary vane stages. In particular, the depicted portion of the LPT 500 comprises three rotating blade stages 502a, 502b, and 502c and two stationary vane stages 504a and 504b. The rotating blade stages are referred to herein generically or collectively as “a/the rotating blade stage(s) 502” or simply “the blades 502,” and the stationary vane stages are referred to herein generically or collectively as “a/the stationary vane stage(s) 504” or simply “the vanes 504.”

The blades 502 and the vanes 504 are disposed within a duct 506 aft of a TVF 510, which guides the fluid flow through the LPT 500.

Each rotating blade stage 502 of the LPT 500 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect shrouded turbine blades, the tip radius is the radius at the tip of the blade portion, excluding the shroud portion.

The LPT 500 comprises three rotating blade stages, a redline EGT of 1067 degrees Celsius, a first stage exit area of 293.2 in², a second stage exit area of 476 in², a third stage exit area of 764.9 in², an area ratio of 2.61, an area-EGT ratio of 1.51, a first stage AN² value of 30, and a third stage AN² value of 80. AN² the product of A and N², where A is the annular exit area of a particular rotating stage of the low-pressure turbine measured in square inches, N is the rotational speed of the low-pressure turbine measured in revolutions per minute at a redline operating condition, and the product of AN² is divided by 10⁹.

FIG. 9 provides additional information about the LPT 500 (see Engine 09).

FIG. 9 provides a table with several additional examples of gas turbine engines comprising three rotating blade stages, a LPT with an area ratio within a range of 2.0-5.1 (particularly 2.22-2.91) and an area-EGT ratio within a range of 1.05-1.6 (particularly 1.38-1.58). The engines disclosed in FIG. 9 comprise a gear ratio of 2-9 or 2.95-8.33. The EGT at a redline operating condition for the engines of FIG. 9 is within a range of 1060-1175 degrees Celsius or within a range of 1067-1083 degrees Celsius. The exit area of stage 1 of the disclosed engines is within a range of 155-380 in² or within a range of 285.0-372.4 in². The exit area of stage 2 of the engines of FIG. 9 is within a range of 230-750 in² or within a range of 461.8-699.5 in². The exit area of stage 3 of the engines of FIG. 9 is within a range of 350-1050 in² or within a range of 638.5-1027.82 in². The area ratio of the engines disclosed in FIG. 9 is within a range of 2.0-5.1 or within a range of 2.22-2.91. The area-EGT ratio is within a range of 1.05-1.6 or within a range of 1.38-1.58. The engines disclosed in FIG. 9 comprise a first stage AN² value within a range of 9-36 or within a range of 30-36 at a redline operating condition. The engines disclosed in FIG. 9 comprise a third stage (exit) AN² value within a range of 44-105 or within a range of 78-105 at a redline operating condition.

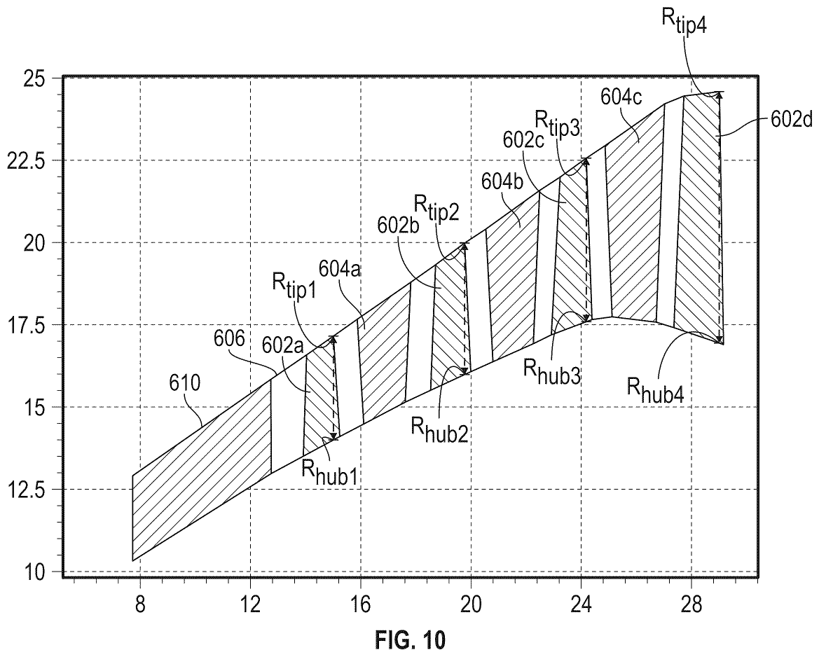

FIGS. 10-12 provide examples of low-pressure turbines comprising four rotating blade stages. The disclosed LPTs comprise an area ratio within a range of 2.0-5.1 (particularly 2.05-5.0, 2.0-3.5) and an area-EGT ratio within a range of 1.05-1.6 (particularly 1.09-1.58).

FIG. 10 depicts a portion of a four-stage low-pressure turbine 600, according to one example of the disclosed technology. The low-pressure turbine 600 can be used, for example, with any of the gas turbine engines disclosed herein (e.g., the engines 10, 100). The LPT 600 comprises a plurality of rotating blade stages and a plurality of stationary vane stages. In particular, the depicted portion of the LPT 600 comprises four rotating blade stages 602a, 602b, 602c, and 602d and three stationary vane stages 604a, 604b, and 604c. The rotating blade stages are referred to herein generically or collectively as “a/the rotating blade stage(s) 602” or simply “the blades 602,” and the stationary vane stages are referred to herein generically or collectively as “a/the stationary vane stage(s) 604” or simply “the vanes 604.”

It was found that a four-stage high speed low-pressure turbine (LPT) provides an improved geared engine configuration that best accommodates advances in propulsion and provides the balance between engine weight, engine size, and the efficient conversion of kinetic energy into mechanical power for driving a fan and a low-pressure compressor (which can also be referred to as a “booster”). Additional work will be needed as overall pressure ratios (OPR) are increased to improve engine performance while maintaining the pressure ratio of a known high-pressure compressor (HPC) design. For future engines as temperatures increase for improved thermal efficiency, the core gets smaller, which increases the loading on the low-pressure turbine. This will require an increased stage count. Utilizing an existing or scaled HPC design will minimize development cost by using the same or slightly improved characteristics on the HPC of an in-service engine. The four-stage LPT can balance loading from the additional work to maximize efficiency while limiting weight addition and size increases. A higher LPT stage count (e.g., 5 or higher) may in some instances also achieve a target loading but at the expense of a longer, heavier, and more expensive LPT design. A three-stage design, can, in some instances, require a max radius increase and/or increased rotor speed.

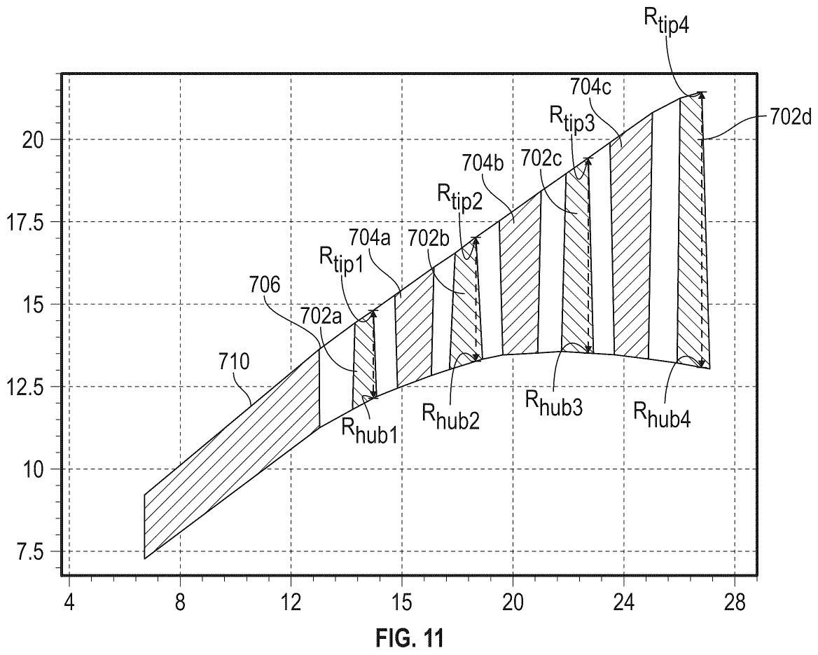

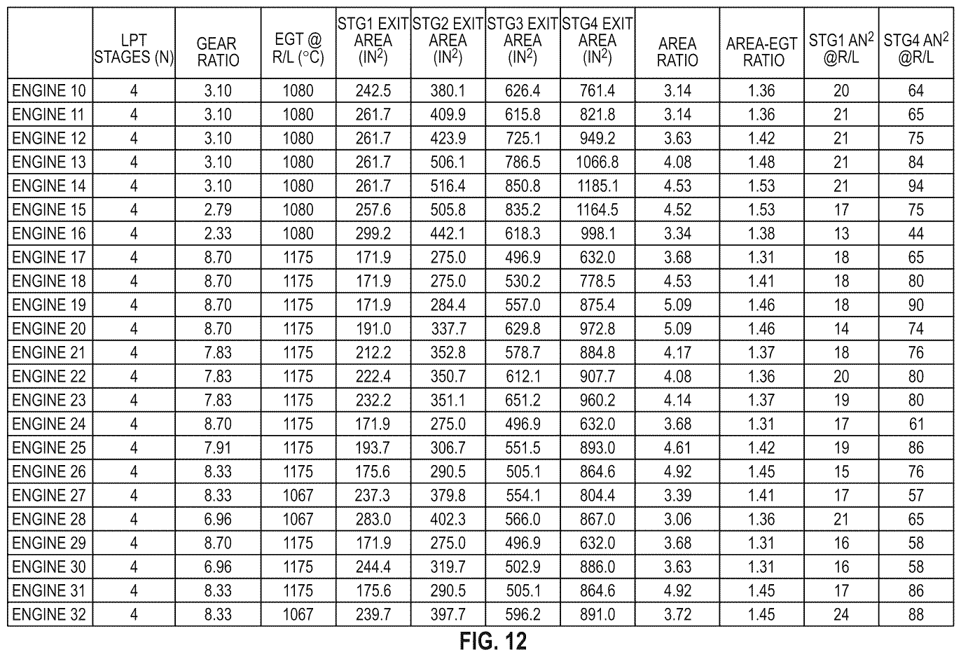

The desired area ratio range for a four-stage high speed LPT avoids the drawbacks for a design that falls outside of the area ratio range of 2.0-5.1. A four-stage LPT design with an area ratio higher than 5.1 can require (1) an increased flowpath slope resulting in additional secondary flow losses and an increased risk of separation, and/or (2) an increased length resulting in larger profile losses, weight, and installation penalties. A four-stage LPT design with an area ratio below 2.0 can result in higher than desired Mach numbers through the LPT. Undesirably high Mach numbers can produce additional losses in the LPT and/or other downstream components. FIG. 13 provides several examples of four-stage LPT designs that would produce a less desired outcome (for one or more of the above reasons) than the exemplary four-stage LPT designs provided in FIG. 12. For example, Engine 33 (FIG. 13) is generally similar to Engine 29 (FIG. 12), but Engine 33 has an area ratio less than 2.0 (i.e., 1.8). Accordingly, Engine 33 will have higher than desired Mach numbers through the LPT resulting in additional losses in the LPT and/or downstream components. As another example, Engine 38 (FIG. 13) is generally similar to Engine 30 (FIG. 12), but Engine 38 has an area ratio higher than 5.1 (i.e., 6.75). As such, Engine 38 has an undersirably high flowpath slope resulting in additional secondary flow losses and an increased risk of separation.

In some instances, an LPT with an area ratio of 2.0-3.5 can be particularly advantageous. Configuring an LPT with an area ratio within this range can, for example, result in optimum fuel burn for the engine by balancing profile and secondary loss plus weight and installation effects.

The blades 602 and the vanes 604 are disposed within a duct 606 aft of a TVF 610, which guides the fluid flow through the LPT 600.

Each rotating blade stage 602 of the LPT 600 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect to shrouded turbine blades, the tip radius is the radius at the tip of the blade portion, excluding the shroud portion.

The LPT 600 comprises four rotating blade stages, a redline EGT of 1080 degrees Celsius, a first stage exit area of 299.2 in², a second stage exit area of 442.1 in², a third stage exit area of 618.3 in², a fourth stage exit area of 998.1 in², an area ratio of 3.34, an area-EGT ratio of 1.38, a first stage AN² value of 13, and a fourth stage AN² value of 44.

FIG. 11 depicts a portion of a four-stage low-pressure turbine 700, according to one example of the disclosed technology. The low-pressure turbine 700 can be used, for example, with any of the gas turbine engines disclosed herein (e.g., the engines 10, 100). The LPT 700 comprises a plurality of rotating blade stages and a plurality of stationary vane stages. In particular, the depicted portion of the LPT 700 comprises four rotating blade stages 702a, 702b, 702c, and 702d and three stationary vane stages 704a, 704b, and 704c. The rotating blade stages are referred to herein generically or collectively as “a/the rotating blade stage(s) 702” or simply “the blades 702,” and the stationary vane stages are referred to herein generically or collectively as “a/the stationary vane stage(s) 704” or simply “the vanes 704.”

The blades 702 and the vanes 704 are disposed within a duct 706 aft of a TVF 710, which guides the fluid flow through the LPT 700.

Each rotating blade stage 702 of the LPT 700 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect shrouded turbine blades, the tip radius is the radius at the tip of the blade portion, excluding the shroud portion.

The LPT 700 comprises four rotating blade stages, a redline EGT of 1175 degrees Celsius, a first stage exit area of 222.4 in², a second stage exit area of 350.7 in², a third stage exit area of 612.1 in², a fourth stage exit area of 907.7 in², an area ratio of 4.08, an area-EGT ratio of 1.36, a first stage AN² value of 20, and a fourth stage AN² value of 80.

FIG. 12 provides a table with several additional examples of gas turbine engines comprising four rotating blade stages, a LPT with an area ratio within a range of 2.0-3.5 and an area-EGT ratio within a range of 1.05-1.6. The engines disclosed in FIG. 12 comprise a gear ratio of 2.0-9.0 or 2.6-8.70. The EGT at a redline operating condition for the engines of FIG. 12 is within a range of 1067-1175 degrees Celsius. The exit area of stage 1 of the disclosed engines is within a range of 155-380 in² or within a range of 171.9-299.2 in². The exit area of stage 2 of the engines of FIG. 12 is within a range of 230-750 in² or within a range of 250-579.47 in². The exit area of stage 3 of the engines of FIG. 12 is within a range of 330-1050 in² or within a range of 339-944 in². The exit area of stage 4 of the engines of FIG. 12 is within a range of 420-1400 in² or within a range of 429-1309 in². The area ratio of the engines disclosed in FIG. 12 is within a range of 2.0-5.1 or within a range of 2.0-3.06 or within a range of 3.06-5.09 (3.1-5.1). The area-EGT ratio is within a range of 1.05-1.6 or within a range of 1.05-1.39. The engines disclosed in FIG. 12 comprise a first stage AN² value within a range of 13-22 at a redline operating condition. The engines disclosed in FIG. 12 comprise a fourth stage (exit) AN² value within a range of 29-105 at a redline operating condition.

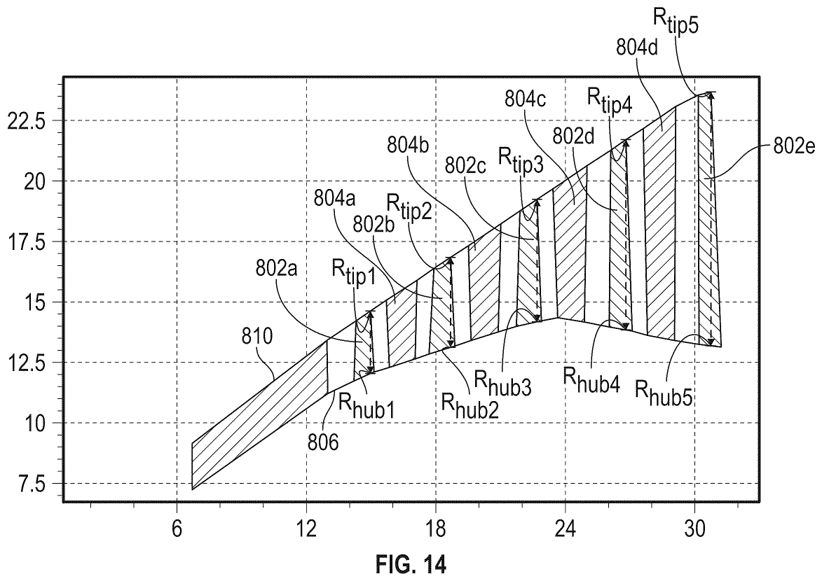

FIGS. 14-16 provide examples of low-pressure turbines comprises five rotating blade stages. The disclosed LPTs comprise an area ratio within a range of greater than 5.1, which have the drawbacks discussed above.

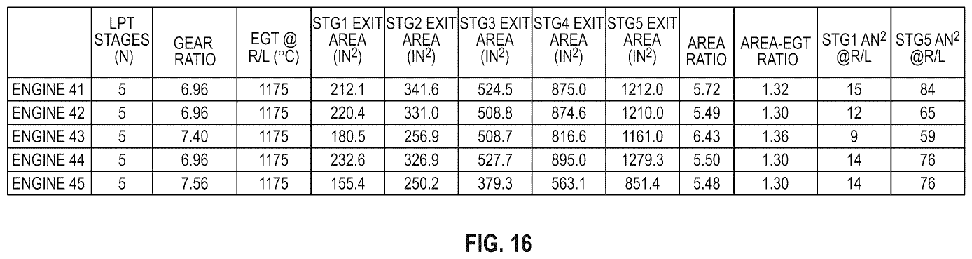

FIG. 14 depicts a portion of a five-stage low-pressure turbine 800, according to one example of the disclosed technology. The low-pressure turbine 800 can be used, for example, with any of the gas turbine engines disclosed herein (e.g., the engines 10, 100), and particularly Engine 41 depicted in the table of FIG. 16. The LPT 800 comprises a plurality of rotating blade stages and a plurality of stationary vane stages. In particular, the depicted portion of the LPT 800 comprises five rotating blade stages 802a, 802b, 802c, 802d, and 802e and four stationary vane stages 804a, 804b, 804c, and 804d. The rotating blade stages are referred to herein generically or collectively as “a/the rotating blade stage(s) 802” or simply “the blades 802,” and the stationary vane stages are referred to herein generically or collectively as “a/the stationary vane stage(s) 804” or simply “the vanes 804.”

The blades 802 and the vanes 804 are disposed within a duct 806 aft of a TVF 810, which guides the fluid flow through the LPT 800.

Each rotating blade stage 802 of the LPT 800 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect to shrouded turbine blades, the tip radius is the radius at the tip of the blade portion, excluding the shroud portion.

The LPT 800 comprises five rotating blade stages, a redline EGT of 1175 degrees Celsius, a first stage exit area of 212.1 in², a second stage exit area of 341.6 in², a third stage exit area of 524.5 in², a fourth stage exit area of 875.0 in², a fifth stage exit area of 1212.0 in², an area ratio of 5.72, an area-EGT ratio of 1.32, a first stage AN² value of 15, and a fifth stage AN² value of 84. FIG. 16 provides additional information about the LPT 800 (see Engine 41).

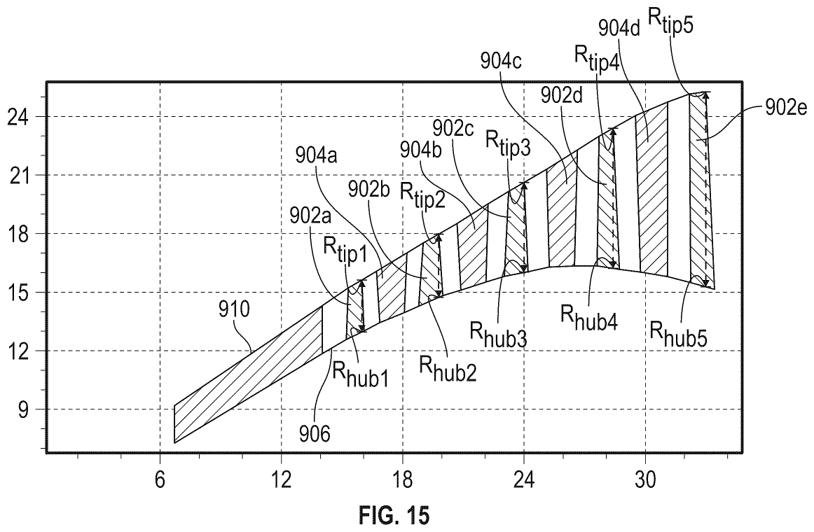

FIG. 15 depicts a portion of a five-stage low-pressure turbine 900, according to one example of the disclosed technology. The low-pressure turbine 900 can be used, for example, with any of the gas turbine engines disclosed herein (e.g., the engines 10, 100), and particularly Engine 44 depicted in the table of FIG. 16. The LPT 900 comprises a plurality of rotating blade stages and a plurality of stationary vane stages. In particular, the depicted portion of the LPT 900 comprises five rotating blade stages 902a, 902b, 902c, 902d, and 902e and four stationary vane stages 904a, 904b, 904c, and 904d. The rotating blade stages are referred to herein generically or collectively as “a/the rotating blade stage(s) 902” or simply “the blades 902,” and the stationary vane stages are referred to herein generically or collectively as “a/the stationary vane stage(s) 904” or simply “the vanes 904.”

The blades 902 and the vanes 904 are disposed within a duct 906 aft of a TVF 910, which guides the fluid flow through the LPT 900.

Each rotating blade stage 902 of the LPT 900 comprises an annular exit area defined by a tip radius of a trailing edge of any blade of the rotating stage (or a nominal tip radius of the stage) and a hub radius of the blade of the rotating stage (or a nominal hub radius of the stage) at the axial location aligned with the tip radius. With respect shrouded turbine blades, the tip radius is the radius at the tip of the blade portion, excluding the shroud portion.

The LPT 900 comprises five rotating blade stages, a redline EGT of 1175 degrees Celsius, a first stage exit area of 232.6 in², a second stage exit area of 326.9 in², a third stage exit area of 527.7 in², a fourth stage exit area of 895.0 in², a fifth stage exit area of 1279.3 in², an area ratio of 5.5, an area-EGT ratio of 1.30, a first stage AN² value of 14, and a fifth stage AN² value of 76. FIG. 16 provides additional information about the LPT 900 (see Engine 44).

FIG. 16 provides a table with several additional examples of gas turbine engines comprising five rotating blade stages, an LPT with an area ratio within a range of 5.4-6.5 and an area-EGT ratio within a range of 1.3-1.6. Due to their area ratio exceeding 5.1, these engines would not perform as well as engines comprising an LPT with an area ratio of 2.0-5.1. The engines disclosed in FIG. 16 comprise a gear ratio of 2.0-9.0 or 6.96-7.56. The EGT at a redline operating condition for the engines of FIG. 15 is within a range of 1060-1175 degrees Celsius, and particularly 1175 degrees Celsius. The exit area of stage 1 of the disclosed engines is within a range of 155-380 in² or within a range of 155.4-232.6 in². The exit area of stage 2 of the engines of FIG. 16 is within a range of 230-750 in² or within a range of 250.2-341.6 in². The exit area of stage 3 of the engines of FIG. 16 is within a range of 350-1050 in² or within a range of 379.3-527.7 in². The exit area of stage 4 of the engines of FIG. 16 is within a range of 630-1200 in² or within a range of 563.1-895 in². The exit area of stage 5 of the engines of FIG. 16 is within a range of 800-1300 in², within a range of 851-1280 in², or within a range of 851.4-1279.3 in². The area ratio of the engines disclosed in FIG. 16 is within a range of 5.4-6.5 or within a range of 5.48-6.43. The area-EGT ratio is within a range of 1.3-1.6 or within a range of 1.30-1.36. The engines disclosed in FIG. 16 comprise a first stage AN² value within a range of 9-36 or within a range of 9-15 at a redline operating condition. The engines disclosed in FIG. 16 comprise a fifth stage (exit) AN² value within a range of 44-104 or within a range of 59-84 at a redline operating condition.

The 3-4 stage low-pressure turbines disclosed herein comprising an area ratio within a range of 2.0-5.1 and an area-EGT ratio within a range of 1.05-1.6 provides one or more advantages over conventional low-pressure turbines. In some examples, the disclosed 3-4 stage LPTs have up to +1.3% (e.g., +0.1% to +1.3%) LPT efficiency compared to conventional LPTs. In some examples, the disclosed LPTs enable reduced LPT stage count or reduced tip speeds, which provides weight and/or cost reduction, without an efficiency penalty. In some examples, the disclosed LPTs enable higher BPR engines without adding LPT stages. In some examples, the disclosed LPTs reduce turbine rear frame (TRF) loss by up to 0.3% dP/P₁ due to the reduced LPT exit Mach number. As used herein, “dP” is the change in fluid pressure across the TRF, and “P₁” is the fluid pressure prior to the TRF. Stated another way, dP/P₁ equals the fluid pressure after the TRF (P₂) minus the fluid pressure prior to the TRF (P₁) divided by P₁. Thus, dP/P₁ is the relative change of the fluid pressure across the TRF. In at least some instances, the LPT exit Mach number of the LPTs disclosed herein can be <0.48.

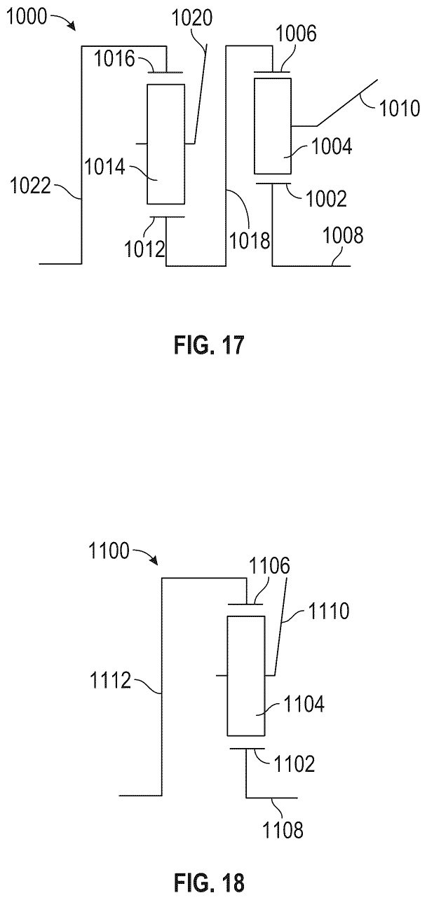

FIG. 17 schematically depicts a gearbox 1000 that can be used with the engines disclosed herein (e.g., the engines 10, 100). The gearbox 1000 comprises a two-stage star configuration.

The first stage of the gearbox 1000 includes a first-stage sun gear 1002, a first-stage carrier 1004 housing a plurality of first-stage star gears, and a first-stage ring gear 1006. The first-stage sun gear 1002 can be coupled to a low-speed shaft 1008, which in turn is coupled to a low-pressure turbine. The first-stage sun gear 1002 can mesh with the plurality of first-stage star gears, which mesh with the first-stage ring gear 1006. The first-stage carrier 1004 can be fixed from rotation by a support member 1010.

The second stage of the gearbox 1000 includes a second-stage sun gear 1012, a second-stage carrier 1014 housing a plurality of second-stage star gears, and a second-stage ring gear 1016. The second-stage sun gear 1012 can be coupled to a shaft 1018 which in turn is coupled to the first-stage ring gear 1006. The second-stage carrier 1014 can be fixed from rotation by a support member 1020. The second-stage ring gear 1016 can be coupled to a fan shaft 1022.

In some examples, each stage of the gearbox 1000 can comprise five star gears. In other examples, the gearbox 1000 can comprise fewer or more than five star gears in each stage. In some examples, the first-stage carrier 1004 can comprise a different number of star gears than the second-stage carrier 1014. For example, the first-stage carrier 1004 can comprise five star gears, and the second-stage carrier 1014 can comprise three star gears, or vice versa.

FIG. 18 schematically depicts a gearbox 1100 that can be used with the engines disclosed herein (e.g., the engines 10, 100). The gearbox 1100 comprises a single-stage star configuration. The gearbox 1100 includes a sun gear 1102, a carrier 1104 housing a plurality of star gears (e.g., 3-5 star gears), and a ring gear 1106. The sun gear 1102 can mesh with the plurality of star gears, and the plurality of star gears can mesh with the ring gear 1106. The sun gear 1102 can be coupled to a low-speed shaft 1108, which in turn is coupled to the low-pressure turbine. The carrier 1104 can be fixed from rotation by a support member 1110. The ring gear 1106 can be coupled to a fan shaft 1112.

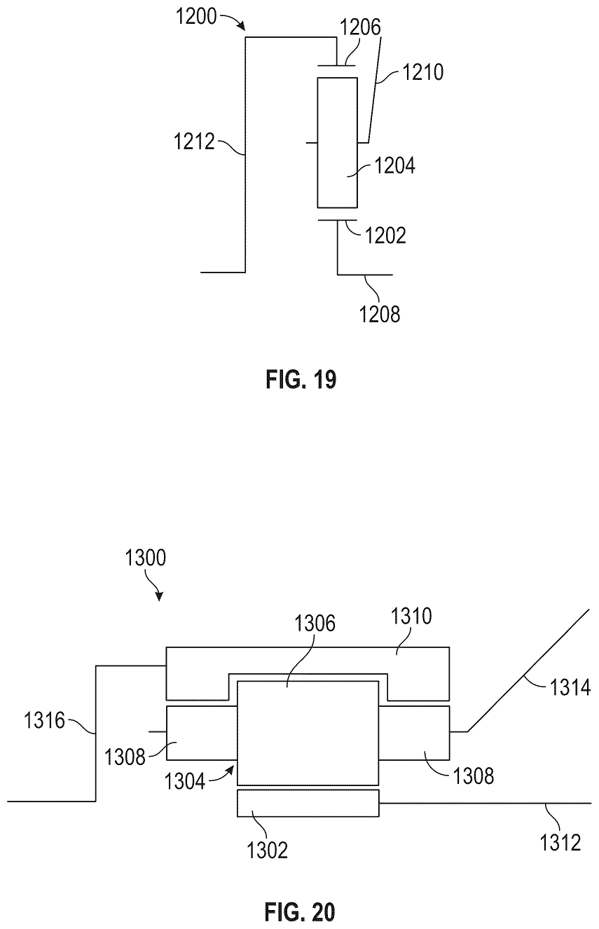

FIG. 19 schematically depicts a gearbox 1200 that can be used with the engines disclosed herein (e.g., the engines 10, 100). The gearbox 1200 comprises a single-stage star configuration. The gearbox 1200 includes a sun gear 1202, a carrier 1204 housing a plurality of star gears (e.g., 3-5 star gears), and a ring gear 1206. The sun gear 1202 can mesh with the plurality of star gears, and the star gears can mesh with the ring gear 1206. The sun gear 1202 can be coupled to a low-speed shaft 1208, which in turn is coupled to the low-pressure turbine. The carrier 1204 can be fixed from rotation by a support member 1210. The ring gear 1206 can be coupled to a fan shaft 1212.

FIG. 20 depicts a gearbox 1300 that can be used, for example, with the engines disclosed herein (e.g., the engines 10, 100). The gearbox 1300 is configured as a compound star gearbox. The gearbox 1300 comprises a sun gear 1302 and a star carrier 1304, which includes a plurality of compound star gears having one or more first portions 1306 and one or more second portions 1308. The gearbox 1300 further comprises a ring gear 1310. The sun gear 1302 can also mesh with the first portions 1306 of the plurality of compound star gears. The star carrier can be fixed from rotation via a support member 1314. The second portions 1308 of the plurality of compound star gears can mesh with the ring gear 1310. The sun gear 1302 can be coupled to a low-pressure turbine via the turbine shaft 1312. The ring gear 1310 can be coupled to a fan shaft 1316.

Various configurations of the gear assembly provided herein may allow for gear ratios of up to 10:1. Still various examples of the gear assemblies provided herein may allow for gear ratios within a range of 2.5-4.0. Still yet various examples of the gear assemblies provided herein allow for gear ratios within a range of 4.1-10.0. Other examples can have a gear ratio within a range of 3.0-4.0. FIGS. 9, 12, 13, and 16 also provide the gear ratio of several exemplary engines.

Various exemplary gear assemblies are shown and described herein, which can also be referred to as a gearbox. These gear assemblies may be utilized with any of the exemplary engines and/or any other suitable engine for which such gear assemblies may be desirable. In such a manner, it will be appreciated that the gear assemblies disclosed herein may generally be operable with an engine having a rotating element with a plurality of rotor blades and a gas turbine having a turbine and a shaft rotatable with the turbine. With such an engine, the rotating element (e.g., fan assembly) may be driven by the shaft (e.g., low-speed shaft) of the gas turbine through the gear assembly.

Although the exemplary gear assemblies shown are mounted at a forward location (e.g., forward from the combustor and/or the low-pressure compressor), in other examples, the gear assemblies described herein can be mounted at an aft location (e.g., aft of the combustor and/or the low-pressure turbine).

Further aspects are provided by the subject matter of the following clauses:

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the fan is a ducted fan, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio greater than 2 and less than 4, wherein a thrust rating for the gas turbine engine is between 20,000 pounds and 45,000 pounds, wherein the FLTCF is greater than or equal to 1.12 and less than or equal to 1.35, and wherein the FLTOR is greater than or equal to 1.06 and less than or equal to 1.19.

The gas turbine engine of any preceding clause, wherein the fan is a ducted fan, wherein the leading edge fan radius R_{Fan_LE} is greater than or equal to 51 inches and less than or equal to 66 inches, wherein the fan defines a fan blade count greater than or equal to 17 and less than or equal to 23, wherein a thrust rating for the gas turbine engine is between 60,000 pounds and 118,000 pounds, wherein the FLTCF is greater than or equal to 1.27 and less than or equal to 1.5, and wherein the FLTOR is greater than or equal to 1.18 and less than or equal to 1.5.

The gas turbine engine of any preceding clause, wherein the fan is a ducted fan, wherein the leading edge fan radius R_{Fan_LE} is greater than or equal to 55 inches and less than or equal to 70 inches, wherein the fan defines a fan blade count greater than or equal to 12 and less than or equal to 22, wherein a thrust rating for the gas turbine engine is between 100,000 pounds and 150,000 pounds, wherein the FLTCF is greater than or equal to 1.46 and less than or equal to 1.65, and wherein the FLTOR is greater than or equal to 1.2 and less than or equal to 1.5.

A gas turbine engine comprising a fan assembly, a low-pressure turbine, and a gearbox. The fan assembly includes a plurality of fan blades. The low-pressure turbine comprises 3-4 rotating stages. Each rotating stage of the low-pressure turbine comprises an annular exit area defined by a tip radius of a trailing edge of any one blade of the rotating stage and a hub radius of the any one blade of the rotating stage at an axial location aligned with the tip radius. The low-pressure turbine comprises an area ratio equal to the annular exit area of an aft-most rotating stage of the low-pressure turbine divided by the annular exit area of a forward-most rotating stage of the low-pressure turbine, and the area ratio is within a range of 2.0-5.1. The gearbox includes an input and an output. The input of the gearbox is coupled to the low-pressure turbine and comprises a first rotational speed, and the output of the gearbox is coupled to the fan assembly and comprises a second rotational speed.

The gas turbine engine of the preceding clause, wherein the area ratio of the low-pressure turbine is within a range of 2.0-3.0.

The gas turbine engine of any preceding clause, wherein the area ratio of the low-pressure turbine is within a range of 2.2-2.7.

The gas turbine engine of any preceding clause, wherein the low-pressure turbine includes exactly three rotating stages, and wherein the area ratio of the low-pressure turbine is within a range of 2.2-2.91.

The gas turbine engine of any preceding clause, wherein the low-pressure turbine includes exactly four rotating stages, and wherein the area ratio of the low-pressure turbine is within a range of 2.0-5.1.

The gas turbine engine of any preceding clause, wherein the fan assembly is a ducted fan assembly disposed radially within a fan case.

The gas turbine engine of any preceding clause, wherein the fan assembly is an unducted fan assembly.

The gas turbine engine of any preceding clause, wherein the fan assembly comprises a first fan and a second fan, each comprising a plurality of fan blades, wherein the second fan is disposed aft of the first fan and has a smaller diameter than the first fan, and wherein the gas turbine engine is a three-stream engine.

The gas turbine engine of any preceding clause, wherein the low-pressure turbine comprises an AN² value within a range of 20-70, where A is the annular exit area of the aft-most rotating stage of the low-pressure turbine measured in square inches, N is the rotational speed of the low-pressure turbine measured in revolutions per minute at a redline operating condition, and the product of AN² is divided by 10⁹.

The gas turbine of any preceding clause, wherein the low-pressure turbine further comprises an area-EGT ratio within a range of 1.05-1.6, wherein the area-EGT

$$ratio = \frac{{( the area ratio )}^{( 1 / ( LPT stages - 1 ) )}}{( EGT / 1000 )} ,$$

where the LPT stages is the number of rotating stages of the low-pressure turbine, and the EGT is an exhaust gas temperature of the low-pressure turbine measured in degrees Celsius at an inlet of the low-pressure turbine at a redline operating condition.

The gas turbine engine of any preceding clause, wherein an/the exhaust gas temperature of the low-pressure turbine is within a range of 1060-1180 degrees Celsius measured at an/the inlet of the low-pressure turbine at a/the redline operating condition.

The gas turbine engine of any preceding clause, wherein a gear ratio of the first rotational speed to the second rotational speed is within a range of 2.0-3.5.

The gas turbine engine of any preceding clause, wherein a gear ratio of the first rotational speed to the second rotational speed is within a range of 2.5-3.5.

The gas turbine engine of any preceding clause, wherein a gear ratio of the first rotational speed to the second rotational speed is within a range of 2.75-4.1.

The gas turbine engine of any preceding clause, wherein a gear ratio of the first rotational speed to the second rotational speed is within a range of 2.0-4.1.

The gas turbine engine of any preceding clause, wherein a gear ratio of the first rotational speed to the second rotational speed is within a range of 3.0-3.5.

The gas turbine engine of any preceding clause, wherein a gear ratio of the first rotational speed to the second rotational speed is within a range of 3.0-4.0.

The gas turbine engine of any preceding clause, wherein a gear ratio of the first rotational speed to the second rotational speed is within a range of 2.3-3.3.

The gas turbine engine of any preceding clause, wherein a gear ratio of the first rotational speed to the second rotational speed is within a range of 3.0-3.3.

A gas turbine engine comprising a fan assembly, a low-pressure turbine, and a gearbox. The fan assembly includes a plurality of fan blades. The low-pressure turbine comprising 3-4 rotating stages. Each rotating stage of the low-pressure turbine comprises an annular exit area defined by a tip radius of a trailing edge of any one blade of the rotating stage and a hub radius of the any one blade of the rotating stage at an axial location aligned with the tip radius. The low-pressure turbine comprises an area ratio equal to the annular exit area of an aft-most rotating stage of the low-pressure turbine divided by the annular exit area of a forward-most rotating stage of the low-pressure turbine, and the area ratio is within a range of 2.0-5.1. The gearbox including an input and an output. The input of the gearbox is coupled to the low-pressure turbine and comprises a first rotational speed, the output of the gearbox is coupled to the fan assembly and has a second rotational speed, and a gear ratio of the first rotational speed to the second rotational speed is within a range of 3.0-3.5.

The gas turbine engine of any preceding clause, wherein the area ratio of the low-pressure turbine is within a range of 2.2-3.2.

The gas turbine engine of any preceding clause, wherein the low-pressure turbine includes exactly three rotating stages, and wherein the area ratio of the low-pressure turbine is within a range of 2.2-2.6.

The gas turbine engine of any preceding clause, wherein the low-pressure turbine includes exactly four rotating stages, and wherein the area ratio of the low-pressure turbine is within a range of 2.3-2.7.

The gas turbine engine of any preceding clause, wherein the fan assembly is a ducted fan assembly.

The gas turbine engine of any preceding clause, wherein the ducted fan assembly comprises a first ducted fan and a second ducted fan, each comprising a plurality of fan blades, wherein the second ducted fan is disposed aft of the first ducted fan and has a smaller diameter than the first ducted fan, and wherein the gas turbine engine is a three-stream engine.

The gas turbine engine of any preceding clause, wherein the low-pressure turbine comprises an AN² value within a range of 20-70, where A the annular exit area of the aft-most rotating stage of the low-pressure turbine measured in square inches, N is the rotational speed of the low-pressure turbine measured in revolutions per minute at a redline operating condition, and a product of AN² is divided by 10⁹.

The gas turbine of any preceding clause, wherein the low-pressure turbine further comprises an area-EGT ratio within a range of 1.05-1.6, wherein the area-EGT

$$ratio = \frac{{( the area ratio )}^{( 1 / ( LPT stages - 1 ) )}}{( EGT / 1000 )} ,$$

where the LPT stages is a number of rotating stages of the low-pressure turbine, and the EGT is an exhaust gas temperature of the low-pressure turbine measured in degrees Celsius at an inlet of the low-pressure turbine at a redline operating condition.

The gas turbine engine of any preceding clause, wherein an/the exhaust gas temperature of the low-pressure turbine is within a range of 1060-1180 degrees Celsius measured at an/the inlet of the low-pressure turbine at a/the redline operating condition.

The gas turbine engine of any preceding clause, wherein the fan assembly comprises 16-22 fan blades, and wherein the gas turbine engine further comprises a low-pressure compressor comprising 1-8 stages, a high-pressure compressor comprising 8-11 stages, and a high-pressure turbine comprising 1-2 stages.

The gas turbine engine of any preceding clause, wherein: the fan assembly comprises 18-20 fan blades; the low-pressure compressor comprises 3-4 stages; the high-pressure compressor comprises 8-9 stages; and the high-pressure turbine comprises 2 stages.

A gas turbine engine comprising a fan assembly, a low-pressure turbine, and a gearbox. The fan assembly includes a plurality of fan blades. The low-pressure turbine comprises 3-4 rotating stages. Each rotating stage of the low-pressure turbine comprises an annular exit area defined by a tip radius of a trailing edge of any one blade of the rotating stage and a hub radius of the any one blade of the rotating stage at an axial location aligned with the tip radius. The low-pressure turbine comprises an area ratio equal to the annular exit area of an aft-most rotating stage of the low-pressure turbine divided by the annular exit area of a forward-most rotating stage of the low-pressure turbine, and the area ratio is within a range of 2.0-5.1. The gearbox includes an input and an output. The input of the gearbox is coupled to the low-pressure turbine and comprises a first rotational speed, the output of the gearbox is coupled to the fan assembly and has a second rotational speed, and a gear ratio of the first rotational speed to the second rotational speed is within a range of 2.3-3.3.

The gas turbine engine of any preceding clause, wherein the gear ratio is within a range of 3.0-3.3.

The gas turbine engine of any preceding clause, wherein the area ratio of the low-pressure turbine is within a range of 2.0-2.6.

The gas turbine engine of any preceding clause, wherein the low-pressure turbine includes exactly four rotating stages.

The gas turbine engine of any preceding clause, wherein the low-pressure turbine includes exactly three rotating stages.

The gas turbine engine of any preceding clause, wherein the fan assembly is an unducted fan assembly.

The gas turbine engine of any preceding clause, further comprising a ducted fan assembly disposed aft of the unducted fan assembly, and wherein the gas turbine engine is a three-stream engine.

The gas turbine engine of any preceding clause, wherein the low-pressure turbine comprises an AN² value within a range of 20-70, where A is the annular exit area of the aft-most rotating stage of the low-pressure turbine measured in square inches, N is the rotational speed of the low-pressure turbine measured in revolutions per minute at a redline operating condition, and a product of AN² is divided by 10⁹.

The gas turbine of any preceding clause, wherein the low-pressure turbine further comprises an area-EGT ratio within a range of 1.05-1.6, wherein the area-EGT

$$ratio = \frac{{( the area ratio )}^{( 1 / ( LPT stages - 1 ) )}}{( EGT / 1000 )} ,$$

where the LPT stages is a number of rotating stages of the low-pressure turbine, and the EGT is an exhaust gas temperature of the low-pressure turbine measured in degrees Celsius at an inlet of the low-pressure turbine at a redline operating condition.

The gas turbine engine of any preceding clause, wherein an/the exhaust gas temperature of the low-pressure turbine is within a range of 1060-1180 degrees Celsius measured at an/the inlet of the low-pressure turbine at a/the redline operating condition.

The gas turbine engine of any preceding clause, wherein the fan assembly comprises 8-22 fan blades. The gas turbine engine further comprises a low-pressure compressor comprising 1-5 stages, a high-pressure compressor comprising 7-11 stages, a high-pressure turbine comprising 1-2 stages.

The gas turbine engine of any preceding clause, wherein: the fan assembly comprises 12-18 fan blades; the low-pressure compressor comprises 3-4 stages; the high-pressure compressor comprises 8-10 stages; and the high-pressure turbine comprises 2 stages.

A gas turbine engine comprising a fan assembly, a low-pressure turbine, and a gearbox. The fan assembly including a plurality of fan blades. The low-pressure turbine comprises 3-4 rotating stages and an area-EGT ratio within a range of 1.05-1.6. The area-EGT

$$ratio = \frac{{( area ratio )}^{( 1 / ( LPT stages - 1 ) )}}{( EGT / 1000 )} .$$

Each rotating stage of the low-pressure turbine comprises an annular exit area defined by a tip radius of a trailing edge of any one blade of the rotating stage and a hub radius of the any one blade of the rotating stage at an axial location aligned with the tip radius. The area ratio is the annular exit area of an aft-most rotating stage of the low-pressure turbine divided by the annular exit area of a forward-most rotating stage of the low-pressure turbine. The LPT stages is the number of rotating stages of the low-pressure turbine. The EGT is an exhaust gas temperature of the low-pressure turbine measured in degrees Celsius at an inlet of the low-pressure turbine at a redline operating condition. The gearbox including an input and an output. The input of the gearbox is coupled to the low-pressure turbine and comprises a first rotational speed, and the output of the gearbox is coupled to the fan assembly and has a second rotational speed.

The gas turbine engine of any preceding clause, wherein the area-EGT ratio is within a range of 1.05-1.3.

The gas turbine engine of any preceding clause, wherein the area-EGT ratio is within a range of 1.31-1.53.

The gas turbine engine of any preceding clause, wherein the area-EGT ratio is within a range of 1.2-1.36.

The gas turbine engine of any preceding clause, wherein the area ratio of the low-pressure turbine is within a range of 2.0-3.5.

The gas turbine engine of any preceding clause, wherein the low-pressure turbine includes exactly three rotating stages, and wherein the area ratio of the low-pressure turbine is within a range of 2.0-2.91.

The gas turbine engine of any preceding clause, wherein the low-pressure turbine includes exactly four rotating stages, and wherein the area ratio of the low-pressure turbine is within a range of 2.0-3.2.

The gas turbine engine of any preceding clause, wherein the fan assembly is a ducted fan assembly disposed radially within a fan case.

The gas turbine engine of any preceding clause, wherein the fan assembly is an unducted fan assembly.

The gas turbine engine of any preceding clause, wherein the fan assembly comprises a first fan and a second fan, each comprising a plurality of fan blades, wherein the second fan is disposed aft of the first fan and has a smaller diameter than the first fan, and wherein the gas turbine engine is a three-stream engine.

The gas turbine engine of any preceding clause, wherein the low-pressure turbine comprises an AN² value within a range of 25-70, where A is the annular exit area of the aft-most rotating stage of the low-pressure turbine measured in square inches, N is the rotational speed of the low-pressure turbine measured in revolutions per minute at a redline operating condition, and a product of AN² is divided by 10⁹.

The gas turbine engine of any preceding clause, wherein the exhaust gas temperature of the low-pressure turbine is within a range of 1060-1180 degrees Celsius measured at the inlet of the low-pressure turbine at the redline operating condition.

The gas turbine engine of any preceding clause, wherein a gear ratio of the first rotational speed to the second rotational speed is within a range of 2.0-4.0.

The gas turbine engine of any preceding clause, wherein a gear ratio of the first rotational speed to the second rotational speed is within a range of 2.5-3.5.

The gas turbine engine of any preceding clause, wherein a gear ratio of the first rotational speed to the second rotational speed is within a range of 3.0-3.3.

The gas turbine engine of any preceding clause, wherein a gear ratio of the first rotational speed to the second rotational speed is within a range of 2.75-3.5.

The gas turbine engine of any preceding clause, wherein a gear ratio of the first rotational speed to the second rotational speed is within a range of 3.0-4.0.

The gas turbine engine of any preceding clause, wherein a gear ratio of the first rotational speed to the second rotational speed is within a range of 2.25-3.25.

A turbine for an aircraft engine comprising 3-4 rotating stages and an area ratio within a range of 2.0-5.1. Each rotating stage comprises an annular exit area defined by a tip radius of a trailing edge of any one blade of the rotating stage and a hub radius of the any one blade of the rotating stage at an axial location aligned with the tip radius. The area ratio equals the annular exit area of an aft-most rotating stage divided by the annular exit area of a forward-most rotating stage.

The turbine of any preceding clause, wherein the turbine is a low-pressure turbine disposed aft of a high-pressure turbine.

A turbine for an aircraft engine comprising 3-4 rotating stages and an area-EGT ratio within a range of 1.05-1.6. The area-EGT

$$ratio = \frac{{( area ratio )}^{( 1 / ( stages - 1 ) )}}{( EGT / 1000 )} .$$

Each rotating stage comprises an annular exit area defined by a tip radius of a trailing edge of any one blade of the rotating stage and a hub radius of the any one blade of the rotating stage at an axial location aligned with the tip radius. The area ratio is the annular exit area of an aft-most rotating stage divided by the annular exit area of a forward-most rotating stage, wherein the stages is the number of rotating stages. The EGT is an exhaust gas temperature measured in degrees Celsius at an inlet of the turbine at a redline operating condition.

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{L E}} \times {R}_{{Hub}_{T E}}}{{R}_{{Fan}_{TE}} \times {R}_{{Hub}_{LE}}} ,$$

wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, and wherein the area ratio is within a range of 2.0-6.5.

The gas turbine engine of any preceding clause, wherein the area ratio is within a range of 2.0-5.1.

The gas turbine engine of any preceding clause, wherein the drive turbine further comprises an area-EGT ratio within a range of 1.05-1.6, wherein the area-EGT

$$ratio = \frac{{( the area ratio )}^{( 1 / ( LPT stages - 1 ) )}}{( EGT / 1000 )} ,$$

wherein the LPT stages is the number of rotating stages of the drive turbine, and wherein the EGT is an exhaust gas temperature of the drive turbine measured in degrees Celsius at an inlet of the drive turbine at a redline operating condition.

The gas turbine engine of any preceding clause, wherein the area-EGT ratio is within a range of 1.2-1.6.

The gas turbine engine of any preceding clause, wherein the area-EGT ratio is within a range of 1.2-1.3.

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, further comprising an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{L E}} - {R}_{{Hub}_{LE}}}{{R}_{{Fan}_{TE}} - {R}_{{Hub}_{TE}}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{L E}} - {R}_{{Hub}_{LE}}}{{R}_{{Fan}_{TE}} - {R}_{{Hub}_{TE}}} ,$$

wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, and wherein the area ratio is within a range of 2.0-6.5.

The gas turbine engine of any preceding clause, wherein the area ratio is within a range of 2.0-5.1.

The gas turbine engine of any preceding clause, wherein the drive turbine further comprises an area-EGT ratio within a range of 1.05-1.6, wherein the area-EGT

$$ratio = \frac{{( the area ratio )}^{( 1 / ( LPT stages - 1 ) )}}{( EGT / 1000 )} ,$$

wherein the LPT stages is the number of rotating stages of the drive turbine, and wherein the EGT is an exhaust gas temperature of the drive turbine measured in degrees Celsius at an inlet of the drive turbine at a redline operating condition.

The gas turbine engine of any preceding clause, wherein the area-EGT ratio is within a range of 1.2-1.6.

The gas turbine engine of any preceding clause, wherein the area-EGT ratio is within a range of 1.2-1.3.

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further comprising an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{L E}} \times {R}_{{Hub}_{T E}}}{{R}_{{Fan}_{TE}} \times {R}_{{Hub}_{LE}}} .$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius RR_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{L E}} \times {R}_{{Hub}_{T E}}}{{R}_{{Fan}_{TE}} \times {R}_{{Hub}_{LE}}} ,$$

wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, wherein the drive turbine further comprises an area-EGT ratio within a range of 1.2-1.6, wherein the area-EGT

$$ratio = \frac{{( the area ratio )}^{( 1 / ( LPT stages - 1 ) )}}{( EGT / 1000 )} ,$$

wherein the LPT stages is the number of rotating stages of the drive turbine, and wherein the EGT is an exhaust gas temperature of the drive turbine measured in degrees Celsius at an inlet of the drive turbine at a redline operating condition.

The gas turbine engine of any preceding clause, wherein the area-EGT ratio is within a range of 1.2-1.3.

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{L E}} - {R}_{{Hub}_{LE}}}{{R}_{{Fan}_{TE}} - {R}_{{Hub}_{TE}}} ,$$

wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, wherein the drive turbine further comprises an area-EGT ratio within a range of 1.2-1.6, wherein the area-EGT

$$ratio = \frac{{( the area ratio )}^{( 1 / ( LPT stages - 1 ) )}}{( EGT / 1000 )} ,$$

wherein the LPT stages is the number of rotating stages of the drive turbine, and wherein the EGT is an exhaust gas temperature of the drive turbine measured in degrees Celsius at an inlet of the drive turbine at a redline operating condition.

The gas turbine engine of any preceding clause, wherein the area-EGT ratio is within a range of 1.2-1.3.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine defining a radial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan;
wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{L E}} \times {R}_{{Hub}_{T E}}}{{R}_{{Fan}_{TE}} \times {R}_{{Hub}_{LE}}} ,$$
wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, and wherein the area ratio is within a range of 2.0-6.5.

2. The gas turbine engine of claim 1, wherein the area ratio is within a range of 2.0-5.1.

3. The gas turbine engine of claim 1, wherein the drive turbine further comprises an area-EGT ratio within a range of 1.05-1.6,
wherein the area-EGT
$$ratio = \frac{{( the area ratio )}^{( 1 / ( LPT stages - 1 ) )}}{( EGT / 1000 )} ,$$
wherein the LPT stages is the number of rotating stages of the drive turbine, and
wherein the EGT is an exhaust gas temperature of the drive turbine measured in degrees Celsius at an inlet of the drive turbine at a redline operating condition.

4. The gas turbine engine of claim 3, wherein the area-EGT ratio is within a range of 1.2-1.3.

5. The gas turbine engine of claim 1, wherein the FLTCF is greater than or equal to 1.07 and less than or equal to 1.65.

6. The gas turbine engine of claim 1, wherein the bypass ratio is greater than or equal to 13 and less than or equal to 25.

7. The gas turbine engine of claim 1, wherein the turbomachine comprises a compressor section having a low pressure compressor and a high pressure compressor, wherein the low pressure compressor is rotatable with the drive turbine.

8. The gas turbine engine of claim 1, further comprising an outer nacelle surrounding at least in part the fan.

9. The gas turbine engine of claim 1, wherein the fan is an unducted fan.

10. The gas turbine engine of claim 9, wherein the leading edge fan radius R_{Fan_LE} is greater than or equal to 65 inches and less than or equal to 85 inches, and wherein the fan defines a fan blade count greater than or equal to 5 and less than or equal to 15.

11. The gas turbine engine of claim 9, wherein the FLTCF is greater than or equal to 1.07 and less than or equal to 1.25.

12. The gas turbine engine of claim 1, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

13. The gas turbine engine of claim 12, wherein the FLTCF is greater than or equal to 1.12 and less than or equal to 1.35.

14. The gas turbine engine of claim 1, wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{L E}} - {R}_{{Hub}_{LE}}}{{R}_{{Fan}_{TE}} - {R}_{{Hub}_{TE}}} .$$

15. A gas turbine engine defining a radial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and
a reduction gearbox mechanically coupling the drive turbine of the turbomachine to the fan;
wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{L E}} - {R}_{{Hub}_{LE}}}{{R}_{{Fan}_{TE}} - {R}_{{Hub}_{TE}}} ,$$
wherein each rotating stage of the drive turbine comprises an annular exit area defined by a tip radius of a trailing edge of any one blade of the rotating stage and a hub radius of the any one blade of the rotating stage at an axial location aligned with the tip radius, wherein the drive turbine comprises an area ratio equal to the annular exit area of an aft-most rotating stage of the drive turbine divided by the annular exit area of a forward-most rotating stage of the drive turbine, and wherein the area ratio is within a range of 2.0-6.5.

16. The gas turbine engine of claim 15, wherein the area ratio is within a range of 2.0-5.1.

17. The gas turbine engine of claim 15, wherein the drive turbine further comprises an area-EGT ratio within a range of 1.05-1.6,
wherein the area-EGT
$$ratio = \frac{{( the area ratio )}^{( 1 / ( LPT stages - 1 ) )}}{( EGT / 1000 )} ,$$
wherein the LPT stages is the number of rotating stages of the drive turbine, and
wherein the EGT is an exhaust gas temperature of the drive turbine measured in degrees Celsius at an inlet of the drive turbine at a redline operating condition.

18. The gas turbine engine of claim 17, wherein the area-EGT ratio is within a range of 1.2-1.3.

19. The gas turbine engine of claim 15, wherein the FLTOR is greater than or equal to 1.05 and less than or equal to 1.3.

20. The gas turbine engine of claim 15, wherein the bypass ratio is greater than or equal to 13 and less than or equal to 25.
